(19) United States
(12) Patent Application Publication
(10) Pub. No.: US 2022/0004617 A1
(43) Pub. Date: Jan. 6, 2022

(54) PASSWORDLESS AUTHENTICATION SYSTEMS AND METHODS

(71) Applicant: ORCHID SOUND TECHNOLOGIES LLC, Stamford, CT (US)

(72) Inventor: John N. Irwin, III, Greenwich, CT (US)

(21) Appl. No.: 17/290,740

(22) PCT Filed: Oct. 31, 2019
(86) PCT No.: PCT/US2019/059248

§ 371 Date: Apr. 30, 2021

Related U.S. Application Data
(60) Provisional application No. 62/753,305, filed on Oct. 31, 2018.

(51) Int. Cl. G06F 21/40; G06F 21/32; G06F 21/36

(52) U.S. Cl. CPC G06F 21/40; G06F 21/36; G06F 21/32

(57) ABSTRACT

A passwordless authentication method authenticates a user to access a remote computer. A mobile device receives a flash pattern included on a webpage by an authenticator. A body part of a user of the mobile device is biometrically authenticating at the mobile device. Concurrently with the authenticating, a modulated optical signal based upon the flash pattern is emit toward the body part and detected remission of the modulated optical signal by the body part is recorded as a remitted pattern. An indication of authenticity of the user, as determined by the step of biometrically authenticating, and the remitted pattern are communicated to the authenticator, and the user is authenticated to the website based upon the indication of authenticity and a match of the remitted pattern to the flash pattern.

### RELATED APPLICATION

This application claims priority to U.S. Patent Application Ser. No. 62/753,305, titled “Passwordless Authentication”, filed Oct. 31, 2018, and incorporated herein by reference.

### BACKGROUND

Users access many accounts via websites, each typically requiring a login name to identify the user and a password to authenticate access. To reduce the number of passwords to remember, the user may unwisely use the same password with more than one website, thereby increasing the vulnerability to attack by hackers. The user may also simplify the passwords to make them easier to remember and to type, further increasing the vulnerability to attack by hackers. The passwords can also be easily copied, phished, and so on. Further, the website is only authenticating the user based upon the user's knowledge of the password, and thus is not actually authenticating the user, but the user's knowledge of the password instead. Biometric scanning is an alternative to using a password, but requires that the authorizing website receive biometric information of the user attempting authentication, where previously stored (and authenticated) biometric information corresponding to that user is used in comparison with the received biometric information. Repeated transmission of biometric information and storage of the biometric information on many different servers is also a vulnerability.

### SUMMARY

One aspect of the present embodiments includes the realization that a password is not a secure way of authenticating a person accessing a web site, and that requiring a biometric device with every terminal is impractical, and unsecure when biometric information must be transferred to a server for authentication. The present embodiments solve this problem by providing systems and methods for authenticating a user to access a website without requiring a password and without transmitting biometric information to the website or server. Advantageously, the present embodiments use a mobile device (e.g., a smartphone) to perform biometric authentication local to the user and to implement a secure verification of user presence at the time of authentication. The mobile device already implements biometric authentication (e.g., finger print identification, facial identification, etc.) of the user before allowing access to the mobile device functionality, but does not (a) store biometric images on the device in a way that they can be retrieved, nor (b) transmit biometric images to a server. In one example, the mobile device stores a biometric hash that is generated by a biometric sensor (e.g., fingerprint sensor) when performing a biometric scan, where the stored biometric hash cannot be reversed to reveal the biometric information of the user. In another example, the biometric images are stored in a secure enclave on the mobile device that cannot be accessed externally. The biometric hashes and/or securely stored biometric images are generated when the mobile device is initially configured and the user builds trust in the mobile device by providing biometric samples (e.g., fingerprints and/or facial images) that are hashed and/or securely stored within the mobile device. The mobile device may then authenticate a user by capturing a new biometric information sample, hashing it, and comparing the new hash to stored hash values in memory to determine whether the provider of the presented biometric is the user. Alternatively, the mobile device hardware (e.g., a processor chip) internally compares a newly captured biometric image with securely stored biometric images such that the biometric images are not externally accessible.

The present embodiments advantageously combine the biometric authentication of the user by the mobile device with an authentication technique that further verifies that the mobile device and the user are using a computer to access (e.g., login to) a webpage and/or associated account of a website. The website displays a webpage with a QR matrix code that includes (e.g., encodes) a unique identifier (ID) and website information (e.g., a URL) for connecting to an authentication server. The mobile device runs an authentication application (e.g., an app) that controls a camera of the mobile device to read the QR matrix code from the webpage displayed on the computer. Based upon the QR matrix code, the mobile device sends the unique ID to the authentication server, which generates a light-based interval code—temporal code—(e.g., a flash pattern) that is then displayed on the webpage of the computer. The authentication application running on the mobile device uses the camera to capture the temporal code from the computer screen. The authentication application controls the mobile device to authenticate biometrics of the user while simultaneously illuminating the biometric source with a generated flash pattern based upon the temporal code. The flash pattern is remitted by the biometric source (e.g., the user's finger) at the time of biometric authentication and sensed by an optical sensor and a remitted pattern is recorded by the mobile device application. The unique ID, an indication of biometric authentication of the user, and the recorded remitted flash pattern are sent to an authentication server. When the authentication server determines that the received information matches the unique ID and the temporal code generated by the authentication server, and thereafter indicates that the user is authenticated to the mobile device, the authentication server sends an indication to a web server corresponding to the webpage indicating authenticity of the user. Advantageously, the user logs into the webpage without needing to provide a password.

In on embodiment, a passwordless authentication method, includes: receiving, within a mobile device, a flash pattern included on a webpage by an authenticator; biometrically authenticating, at the mobile device, a body part of a user of the mobile device; concurrently with the step of biometrically authenticating: emitting, toward the body part, a modulated optical signal based upon the flash pattern, and recording detected remission of the modulated optical signal by the body part as a remitted pattern; and communicating, to the authenticator, (a) an indication of authenticity of the user, as determined by the step of biometrically authenticating, and (b) the remitted pattern; the user being authenticated to the website based upon the indication of authenticity and a match of the remitted pattern to the flash pattern.

In another embodiment, a passwordless authentication method, includes: receiving, at an authentication server, a computer address of a communication channel to a user computer of a user; communicating webpage content to the computer address, the webpage content including a temporally modulated pattern; receiving from a mobile device separate from the user computer (a) an indication of authentication of the user to the mobile device, as biometrically determined by the mobile device, and (b) a recording of the temporally modulated pattern, as remitted by a body part of the user; and authenticating the user to exchange, via the computer address, restricted-access data with a data server only if (a) the identity, as indicated by the indication, matches a user record of the data server and (b) the recording matches the temporally modulated pattern included in the webpage content.

In another embodiment, a facial-movement tracking method, includes: imaging, at a mobile device, face of a user to authenticate the user to the mobile device based upon the face; and concurrently with the step of imaging, tracking facial movement of the user in response to a challenge command.

In another embodiment, a passwordless authentication method includes: receiving, within a mobile device, a 2D barcode included on a webpage by an authenticator; decoding a unique ID from the 2D barcode; decoding a URL of the authenticator from the 2D barcode; sending the unique ID to the authenticator using the URL; receiving a challenge command from the authenticator via the website; outputting the challenge command to a user of the mobile device; biometrically authenticating the user at the mobile device; concurrently with the step of biometrically authenticating, detecting a response of the user following the challenge command; and communicating, to the authenticator, (a) an indication of authenticity of the user, as determined by the step of biometrically authenticating, and (b) the response of the user. The user is authenticated to the webpage based upon the indication of authenticity and a match of the response to the challenge command.

### BRIEF DESCRIPTION OF THE FIGURES

FIG. 1 shows one example system for passwordless authentication, in an embodiment;

FIG. 2 shows additional example detail for the system of FIG. 1, in embodiments;

FIG. 3 is a flowchart illustrating one example process for passwordless authentication where a flash pattern is displayed on a webpage, in an embodiment;

FIG. 4 is a flowchart illustrating one example process for passwordless authentication where a flash pattern is encoded in a two-dimensional bar code on a webpage, in an embodiment;

FIG. 5 is a flowchart illustrating one example passwordless authentication process using face recognition and a flashing pattern, in an embodiment;

FIG. 6 is a flowchart illustrating one example passwordless authentication process using face recognition, in an embodiment;

FIG. 7 shows one example system for passwordless authentication, in an embodiment;

FIG. 8 is a flowchart illustrating one example passwordless authentication process using face recognition and eye tracking, in an embodiment; and

FIG. 9 is a flowchart illustrating one example passwordless authentication process in an embodiment.

FIG. 10 is a flowchart showing one example process for passwordless authentication using a photoplethysmogram (PPG), in an embodiment.

### DETAILED DESCRIPTION OF THE EMBODIMENTS

Disclosed herein are systems and methods for passwordless authentication based upon modest physical interaction with a user. Passwordless authentication as describe herein allows a user to securely log in to an online account without using a password and without sending biometric information to the server. This secure method for passwordless authentication is advantageously attractive over the alternative of password-based authentication in the prior art. Passwordless authentication as described herein not only removes the need for keeping track of passwords, but may offer better security than password-based authentication.

Biometric information, such as may be obtained through, e.g., fingerprinting, face recognition, or iris recognition, is a candidate replacement for passwords in passwordless authentication, since biometric information, such as a fingerprint, is generally highly unique to each individual user and, conceivably, users would be able to access many different online accounts by touching a fingerprint sensor, or looking at a camera, instead of having to remember a large number of different passwords. However, privacy regulations are likely to prevent or at least limit communication of biometric information.

Embodiments disclosed herein use a mobile device, such as a smartphone, to authenticate a user. Smartphones with biometric authentication capability are ubiquitous, but are only used to authenticate the user to access the smartphone. Advantageously, these embodiments forgo communication of privacy-protected unique biometric information to an authenticator and instead use the smartphone to authenticate the identity of the user, and thereby only communicate data obtained from physical user interaction without revealing privacy-protected biometric information to the authenticating server. The physical user interaction may be performed concurrently with biometric identification by the mobile device, and data obtained from the physical user interaction may be communicated to the authenticating server, such as a central server or a web server, together with an indication of the user's identity obtained from biometric identification (without sending the actual biometric data itself). For example, the physical user interaction may involve the same body part as used for biometric identification. Certain embodiments verify that the body part is alive, as opposed to being a fake replica of the body part. The physical user interaction may be captured using the same sensor that performs biometric identification, e.g., a fingerprint sensor or a face recognition module, and recorded. In an alternative embodiment, the physical user interaction may be captured by the biometric sensor and recorded. In certain embodiments, the disclosed systems and methods allow the user to log in without even typing a user name.

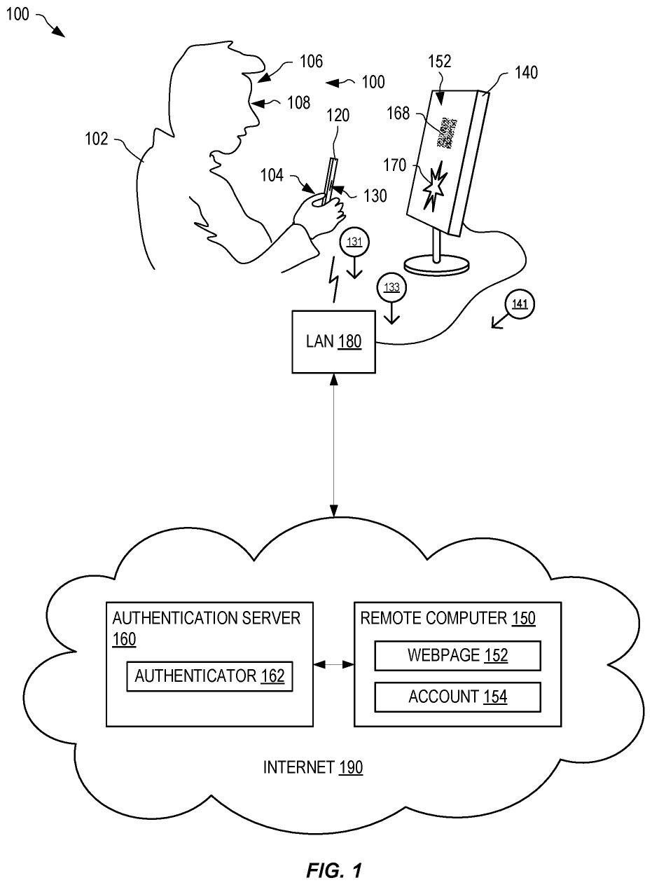

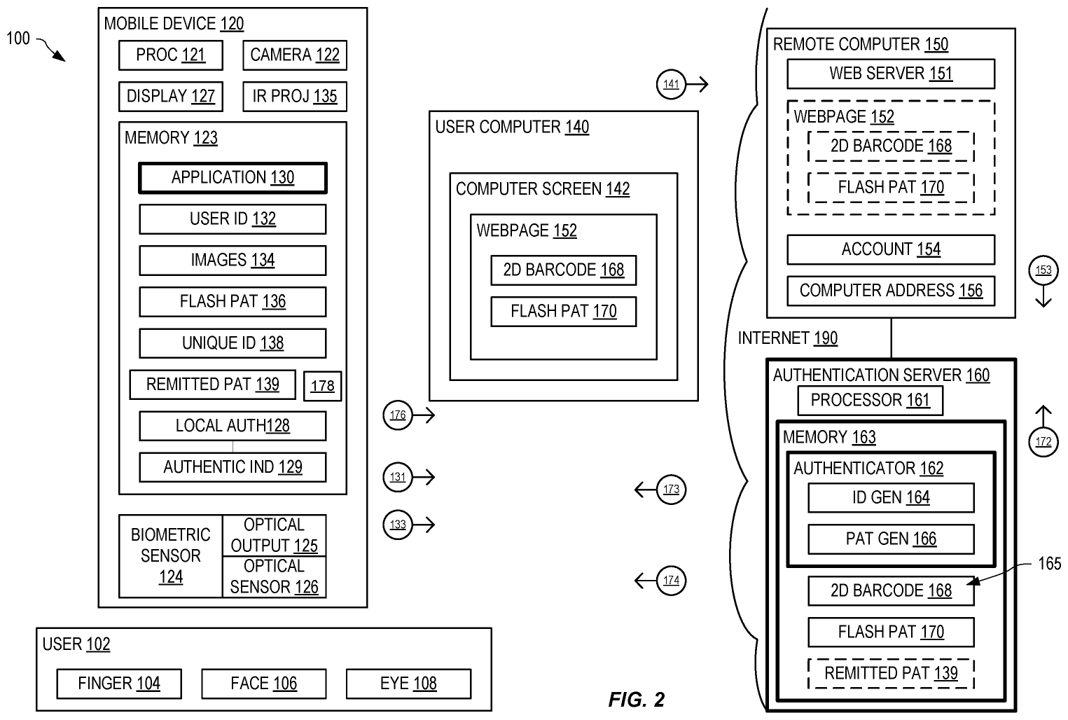

FIG. 1 illustrates one example passwordless authentication system 100. FIG. 2 shows additional example detail of system 100, in embodiments. FIG. 1 and FIG. 2 are best considered together in the following description. A user 102 is required to provide authentication when using a user computer 140 (e.g., local to the user), running a web browser for example, to access an account 154 of a remote computer 150 via a local area network (LAN) 180 and the Internet 190 for example. Account 154 is not limited to any particular account functionality, and may represent any information that is securely accessible via remote computer 150. In response to interaction by user 102, user computer 140 accesses webpage 152 generated by a web server 151. In certain embodiments, web server 151 may communicate with authenticator 162 via the Internet 190. In other embodiments, remote computer 150 and authentication server 160 may be the same server that implements a web server 151 (FIG. 2) and an authenticator 162. A web server 151 of remote computer 150 may cooperate with authenticator 162 of application server 160 to generate a webpage 152 including a two-dimensional barcode (2D barcode) 168 for display by user computer 140. 2D barcode 168 is for example a graphically encoded value that includes a unique identifier (ID) 165 corresponding to a computer address 156 of user computer 140, as determined by web server 151 for example. A data depth of 2D barcode 168 allows for the encoded information to be unique to each instance when user 102 accesses account 154, at least for a certain time interval, such as a duration of at least ten minutes or at least an hour. That is, 2D barcode 168 is unique to a particular authentication attempt at a particular computer.

User 102 has a mobile device 120 (e.g., a smartphone or similar device), that runs an application 130 (e.g., a downloadable device “app”) associated with authenticator 162. Mobile device 120 is capable of biometric authentication (e.g., one or more of fingerprint authentication, facial recognition, iris recognition, etc.), which performs a local biometric authentication of user 102 without sending biometric data to other devices. Mobile device 120 may communicate with authenticator 162 via LAN 180 and/or Internet 190 for example; however, mobile device 120 may use other communication paths (e.g., cellular) without departing from the scope hereof. In embodiments, application 130 outputs operating instructions to user 102, either on display 127 and/or as audibly-spoken instructions. For example, application 130 may display instructions for user 102 to position mobile device 120 so as to capture images of computer screen; it may provide instructions for user to place finger 104 over biometric sensor 124; and so on.

User 102 may initiate application 130, or, in certain embodiments, authenticator 162 may initiate application 130 (described in more detail below), in response to communication from remote computer 150, or in response to camera capturing 2D barcode 168. Application 130 captures an image, using camera 122, of 2D barcode 168 on webpage 152 displayed by computer screen 142 of user computer 140. Application 130 decodes a unique ID 138 from 2D barcode 168 and sends unique ID 138 in a message 131 to authenticator 162 running on authentication server 160. In response, authenticator 162 invokes pattern generator 166 to generate a flash pattern 170.

Flash pattern 170 is generated to be unique to authenticator 162, within a defined period (e.g., one hour, ten minutes, etc.), and may be a temporal sequence of flashes, a temporal sequence of flashing patterns, a temporal pattern of colors, and so on. Particularly, flash pattern 170 is generated for display only on user computer 140 such that it is unique to this access attempt of account 154. Webpage 152 is then updated to display flash pattern 170. In certain embodiments, flash pattern 170 may be displayed as at least part of 2D barcode 168 which then flashes as flash pattern 170. In certain embodiments, the amount of information content of 2D barcode 168 (and, thus, achievable degree of uniqueness of a unique ID 165 encoded therein) may exceed the amount of information content of flash pattern 170.

Application 130 simultaneously biometrically authenticates user 102 with mobile device 120 and captures evidence, based upon flash pattern 170, that user 102 is near user computer 140. For example, application 130 captures the evidence as remitted light from a part (e.g., a finger, face, eye, etc.) of user 102 being used for biometric authentication that is simultaneously exposed to light generated by mobile device 102 to match flash pattern 170. In certain embodiments, this evidence is simultaneously captured by the same sensors that perform the authentication of user 102. Application 130 then sends a message 133 to authenticator 162 indicating (a) unique ID 138, (b) an indication of success or failure of the biometric authentication of user 102, and (c) the captured evidence related to flash pattern 170. Authenticator 162 processes message 133 to authenticate user 102 for accessing account 154. Where message 133 indicates (a) that mobile device 102 successfully authenticated a fingerprint of user 102, and (b) that the username defined by 2D barcode 168 matches the stored identity of user 102 within mobile device 102, and (c) that the captured evidence matches the flash pattern 170, authenticator 162 may determine that user 102 is authenticated (e.g., validated) for accessing account 154, and may notify remote computer 150 accordingly. In certain embodiments, application 130 may encrypt at least part of message 133 by using a public key of authenticator 162, or by adding a code value, or by modifying remitted pattern 139 based upon a code value. Advantageously, this allows authenticator 162 to detect an attempted scam that simply returns the detected flash pattern 168 from webpage 152 and thereby not authenticate the scammer. For example, application 130 may receive an updated code value, at intervals (e.g., weekly), from authenticator 162, thereby further increasing security of the passwordless authentication provided by system 100. In this way, a scammer cannot simply replicate the flash pattern seen on computer screen 142, or decode 2D barcode 168 to determine flash pattern 170, to gain authentication for accessing account 154, since without the correct code, authenticator 162 will not authenticate access.

Advantageously, the use of 2D barcode 168, flash pattern 170, and local biometric authentication by mobile device 120, allows authenticator 162 to authenticate user 102 without requiring a password input, and without biometric images being transmitted from mobile device 102. Particularly, system 100 verifies that user 102 is biometrically identified by mobile device 102, and that user 102 is present at user computer 140 when it is used to access account 154.

Remote computer 150 may represent one or more of a web server, a banking server, an online information source, and so on, where account 154 represents the secured information that user 102 wishes to access.

As shown in FIG. 2, mobile device 120 may represent a smartphone or similar device that includes a processor 121, camera 122, a memory 123, a biometric sensor 124, an optical output 125, and an optical sensor 126. Application 130 is for example a downloadable “app” that includes machine readable instructions that may be downloaded to memory 123 and executed by processor 121 to provide secure communication and cooperation between mobile device 120 and authenticator 162 as described herein. Biometric sensor 124 is for example a fingerprint reader that is co-located with optical output 125 and/or optical sensor 126 such that biometric sensor 124, optical output 125 and/or optical sensor 126 cooperate to provide enhanced biometric authentication of user 102 under control of a local authenticator 128 (e.g., software that implements the user authentication using biometric sensor 124, optical output 125 and/or optical sensor 126 without storing or transmitting captured biometric images). Authenticator 128 is for example an integrated part of mobile device 120 (e.g., a service provided by mobile device 120) that generates an authentic indication 129 based upon matching a hash of a captured biometric image to previously stored biometric hashes, for example.

Biometric sensor 124 and optical sensor 126 may for example represent a combined fingerprint reader as disclosed in WO 2019/032587 A1, titled “Ultrasonic Biometric Sensing Device Integrated with Optics,” filed Aug. 7, 2018, incorporated herein by reference. For example, biometric sensor 124 may be an ultrasonic fingerprint sensing device that captures an image of a fingerprint, and optical output 125 and/or optical sensor 126 may include integrated optics that cooperate to transmit light to, and capture light from, the finger. In embodiments, light from optical output 125 passes through the ultrasonic fingerprint sensing device, where the ultrasonic sensor and the optics operate concurrently to improve authentication of the fingerprint (alternatively, they may operate consecutively with each other, but close in time to ensure that the biometric source also provides the optical sample). In an embodiment, optical output 125 and optical sensor 126 operate in one or both of the visible spectrum and/or the infrared spectrum. The combined fingerprint sensing device may also generate a “liveness” parameter associated with a finger based on remission of the light from optical output 125 captured by optical sensor 126 from the finger, and may, as disclosed herein, also be used to provide evidence that biometric authentication occurred during an access request through a user computer, via the Internet, and a website. In certain embodiments, the combined biometric sensor 124, optical output 125, and optical sensor 126, may have a code that is included with remitted pattern 139 such that authenticator 162 may determine that remitted pattern 139 and fingerprint authentication were determined simultaneously, or temporally close thereto.

In certain embodiments, optical output 125 includes at least one light emitter that generates a flash pattern to illuminate the finger such that remitted light (e.g., partially reflected/scattered light) is sensed by optical sensor 126. In another embodiment, at least part (e.g., a portion near the biometric sensor) of mobile device 120 may be used to output light according to a flash pattern to illuminate the finger such that its remittance from the finger may be sensed by optical sensor 126.

User computer 140 is for example a computing device that includes a processor and memory (not shown) that cooperate to run a web browser (e.g., software) that allows user 102 to interact with webpage 152 displayed on a computer screen 142. User computer 140 may represent one or more of a desktop computer, a laptop computer, a tablet computer, and so on.

Remote computer 150 is for example a cloud based computing device that is accessible via the Internet 190 and includes a processor and memory (not shown). Remote computer 150 may implement a web server 151 that provides web services and web access to information, such as account 154. Web server 151 may implement webpage 152 and interact with user computer 140 (via the Internet 190) and with authenticator 162 (e.g., via the Internet 190 and/or other computer networks). In one example of operation, web server 151 may receive request message 141 from user computer 140, and, in response, generate and send an authentication request 153, containing at least computer address 156 (e.g., an IP address) of user computer 140 and optionally a user ID entered by user 102 to user computer 140, to authenticator 162.

Authentication server 160 includes at least one processor 161 and memory 163 that stores authenticator 162 as machine readable instructions that, when executed by processor 161, implement functionality of authenticator 162 as described herein. Authenticator 162, running on authentication server 160, may provide authentication as a service to remote computer 150 and/or to user 102. Based, at least in part, upon computer address 156 within authentication request 153, authenticator 162 invokes a pattern generator 166 to generate flash pattern 170 that is unique to authenticator 162 within a current time window. In one example of operation, ID generator 164 generates 2D barcode 168 as a QR code that may be displayed in webpage 152 and read, using camera 122, by application 130. In another example, ID generator 164 generates 2D barcode 168 as a bar code that may be similarly read by application 130.

User 102 is shown with three example biometric sources, a finger 104 (e.g., for fingerprint biometric authentication), a face 106 (e.g., for facial biometric authentication), and an eye 108 (e.g., for iris and/or retinal biometric authentication). In certain embodiments, camera 122 may include, or be co-located with, an infrared projector 135 that projects infrared light onto face 106 of user 102 during facial authentication. Advantageously, application 130 may control the infrared projector 135 based upon flash pattern 170 and use camera 122 (or another optical IR detector) to detect remitted pattern 139 from face 106. In certain embodiments, camera 122 (or another optical IR detector) and infrared projector 135 may have a code that is included with remitted pattern 139 such that authenticator 162 may determine that remitted pattern 139 and the facial authentication were determined simultaneously, or temporally close thereto.

Flash pattern 170 may be multi-dimensional and include multiple temporal sequences. Accordingly, flash pattern 170 and corresponding remitted pattern 139 may be determined by a plurality of light outputs and a corresponding plurality of light sensing components. For example, flash pattern 170 may be output as a grid to computer screen 142, where temporal information of each element of the grid is captured separately. Similarly, optical output 125 and optical sensor 126 may each be formed of multiple components, corresponding to the grid of flash pattern 170, to output and detect multiple remissions simultaneously from different portions of finger 104. In another example, infrared projector 135 may project different dimensions of flash pattern 170 onto different portions of face 106, and application 130 may process images 134 to detect remission from these same portions of face 106.

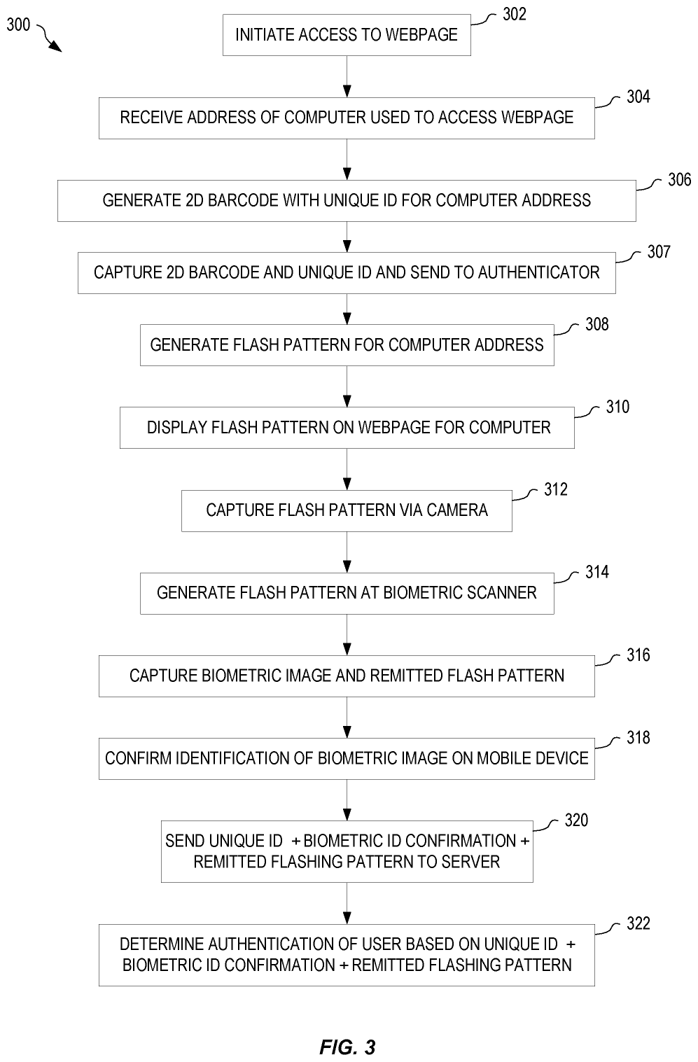

FIG. 3 is a flowchart illustrating one example process 300 for passwordless authentication, where a flash pattern is displayed on a webpage 152. Process 300 may be implemented, at least in part, in authenticator 162 running on authentication server 160 and in application 130 running on mobile device 120. For example, blocks 304-308 and 322 may be implemented by authenticator 162; and block 307, 312-320 may be implemented by application 130.

In block 302, process 300 initiates access to a webpage. In one example of block 302, user 102 displays a webpage 152 of remote computer 150 on computer screen 142 of user computer 140. In block 304, process 300 receives an address of the computer used to access the webpage. In one example of block 304, web server 151 determines computer address 156 (e.g., an IP address) of user computer 140 based upon access to webpage 152, and web server 151 sends computer address 156, and optionally a user ID corresponding to account 154, as authentication request 153, to authenticator 162.

In block 306, process 300 generates a 2D barcode with a unique ID for the computer address. In one example of block 306, authenticator 162 invokes ID generator 164 to generate 2D barcode 168 with unique ID 165 based, at least in part, upon computer address 156. In block 307, process 300 captures the 2D barcode and unique ID and sends them to the authenticator. In one example of block 307, application 130 uses camera 122 to capture an image of computer screen 142 displaying 2D barcode 168, decodes unique identifier 138 from 2D barcode 168 and then sends a message 131 containing unique ID 138 to authenticator 162.

In block 308, process 300 generates a flashing pattern for the computer address. In one example of block 308, in response to authentication request 153, authenticator 162 invokes pattern generator 166 to generate flash pattern 170 based, at least in part, upon computer address 156 (e.g., an IP address) of user computer 140 and a current time, such that flash pattern 170 is unique to concurrent login attempts within a defined period (e.g., ten-minutes, one hour, etc.). In block 310, process 300 displays the flash pattern on the webpage for the computer. In one example of block 310, web server 151 includes flash pattern 170 on webpage 152 that is displayed on computer screen 142 of user computer 140 at the received computer address. That is, the webpage 152 may be specifically generated for viewing only on user computer 140.

In block 312, process 300 captures the flashing pattern via the camera of the mobile device. In one example of block 312, application 130 controls camera 122 of mobile device 120, when appropriately positioned by user 102, to capture a plurality of images 134 of webpage 152 including flash pattern 170. Application 130 processes images 134 to decode unique ID 138 from 2D barcode 168 and to determine flash pattern 136. In certain embodiment, where 2D barcode 168 is encrypted, decoding may also implement decryption (e.g., using a public key of authenticator 162). Accordingly, unique ID 138 uniquely identifies 2D barcode 168 and flash pattern 136 corresponds to flash pattern 170. Particularly, application 130 receives 2D barcode 168 and flash pattern 170 via webpage 152, which is displayed only on computer screen 142.

In block 314, process 300 generates the flash pattern at the biometric scanner. In one example of block 314, application 130 outputs flash pattern 136 via optical output 125 near biometric sensor 124. That is, optical output 125 generates an optical signal that is modulated based upon flash pattern 136. In block 316, process 300 captures a biometric image and remitted flash pattern. In one example of block 316, application 130 may invoke authenticator 128 to control biometric sensor 124 to capture a biometric image of a biometric source presented to biometric sensor 124 (e.g., hashing the captured biometric image), and to concurrently (or immediately sequentially to) capture a remitted pattern 139 from the biometric source (e.g., during illumination by the optical signal) using optical sensor 126 in response to flash pattern 136. In one example, flash pattern 136 is a modulation of an optical signal generated by optical output 125.

In block 318, process 300 confirms identification of the biometric image on the mobile device. In one example of block 318, authenticator 128 may compare the hashed biometric image to a previously stored biometric hash corresponding to user 102 and generate authentic indication 129 to indicate that the known user 102 is presenting the biometric source. In certain embodiments, authentic indication 129 may be a Boolean value that is true only when (a) the biometric image is authenticated to user 102, and (b) a user ID 132, stored within mobile device 120 and corresponding to the authenticable user 102, matches a user ID corresponding to account 154 received within 2D barcode 168 via webpage 152. In certain embodiments, authentic indication 129 may also include a name, a user ID, or another unique alphanumerical code indicating an identity of authenticable user 102 as stored within mobile device 120. However, authentic indication 129 does not include actual biometric data.

In block 320, process 300 sends the unique ID, the confirmation of the biometric identification, and the remitted flash pattern to an authentication server. In one example of block 320, application 130 generates message 133 to include unique ID 138, authentic indication 129, and remitted pattern 139, and sends message 133 to authenticator 162. In another example of block 320, application 130 generates message 133 to include information from 2D barcode 168, authentic indication 129, and remitted pattern 139, and sends message 133 to authenticator 162. Importantly, biometric data is not sent to authenticator 162 and is not accessible on mobile device 120. In certain embodiments, application 130 may encrypt at least part of message 133 by using a public key of authenticator 162 for example, or by adding a code value, or by modifying remitted pattern 139 based upon a code value. Advantageously, this allows authenticator 162 to easily detect an attempted scam that simply returns the detected flash pattern 168 from webpage 152 and thereby not authenticate the scammer. For example, application 130 may receive an code value, at intervals (e.g., weekly), from authenticator 162, thereby further increasing security of the passwordless authentication provided by system 100.

In block 322, process 300 determines authentication of the user based upon the unique ID, the biometric ID confirmation, and the remitted flashing pattern. In one example of block 322, authenticator 162 sends an authentication message 172 to remote computer 150, indicating that user 102 is authenticated (e.g., validated) to account 154, only when each of the following conditions is true: (a) the unique ID 138 received from application 130 matches unique ID 165 of 2D barcode 168, (b) authentic indication 129 indicates that user 102 has been successfully authenticated by mobile device 120, and (c) that the remitted pattern 139 matches flash pattern 170. By matching remitted pattern 139 to flash pattern 170, authenticator 162 ensures that the presented biometric source (e.g., fingerprint or face) occurred at the time when user 102 was requesting access, via webpage 152, to account 154, since flash pattern 170 is uniquely generated and displayed via webpage 152 on computer screen 142 during the access attempt. That is, subsequent access attempts, or access attempts using a different computer, would result in flash pattern 170 being different, and therefore the access to account 154 would not be granted. Thus, user authentic indicator 129 cannot be recorded and resubmitted, but must be captured with each new biometric authentication.

In certain embodiments, authentication system 100 may further implement a reverse data-flow check to further ensure that the authentication and thus access to account 154 is not compromised. For example, once authenticator 162 has validated the user based upon each of (a) the unique ID 138 received from application 130 matches unique ID 165 of 2D barcode 168, (b) authentic indication 129 indicates that user 102 has been successfully authenticated by mobile device 120, and (c) that the remitted pattern 139 matches flash pattern 170, authenticator may generate a character based code that sent (e.g., as message 174) to application 130 and shown on display 127 of mobile device 120. This character based code is then entered by user 102 into a provided field of webpage 152 and returned (e.g., as message 176) to authenticator 162. Where the character based code returned via webpage 152 does not match the character based code generated by authenticator 162, authentication is denied.

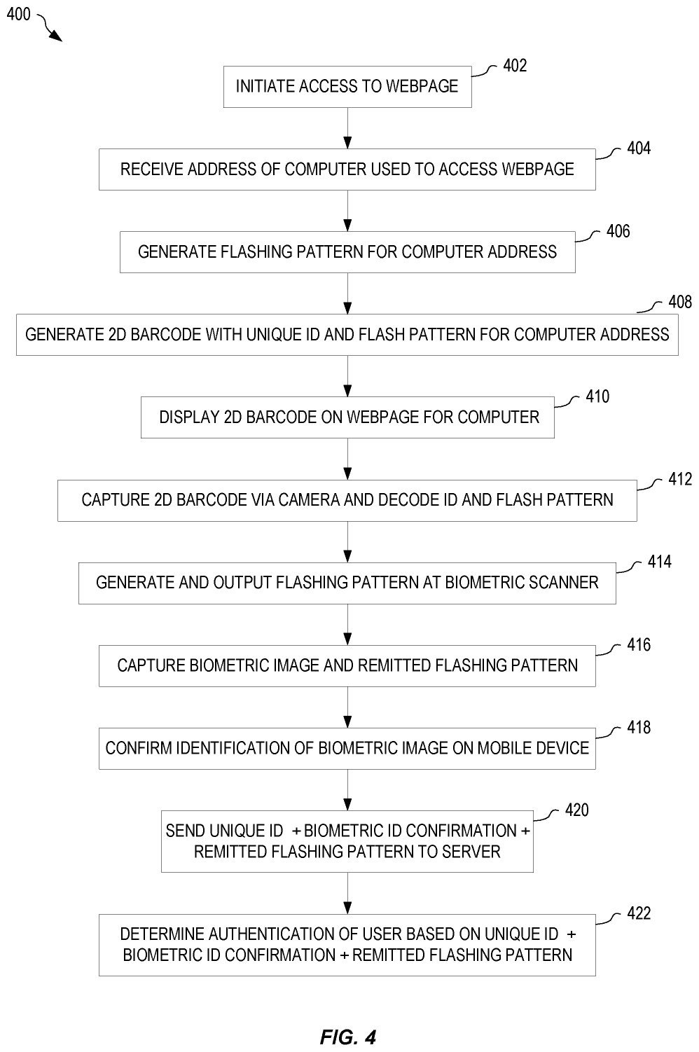

FIG. 4 is a flowchart illustrating another example passwordless authentication process 400 for authenticating, through fingerprinting and processing of a flashing pattern, a user seeking access to information and/or functionality via a webpage on a remote computer. Process 400 is similar to process 300 except that flash pattern 170 is not displayed on the computer screen, but is instead encoded in the 2D barcode. Process 400 is implemented, at least in part, in authenticator 162 and in application 130 running on mobile device 120. For example, blocks 404-408 and 422 may be implemented by authenticator 162; and block 412-420 may be implemented by application 130.

In block 402, process 400 initiates access to a webpage. In one example of block 402, user 102 displays webpage 152 of remote computer 150 on computer screen 142 of user computer 140. In block 404, process 400 receives an address of the computer used to access the webpage. In one example of block 404, web server 151 determines computer address 156 (e.g., an IP address) of user computer 140 based upon access to webpage 152, and web server 151 sends computer address 156, and optionally a user ID corresponding to account 154, as authentication request 153, to authenticator 162.

In block 406, process 400 generates a flashing pattern for the computer address. In one example of block 406, in response to authentication request 153, authenticator 162 invokes pattern generator 166 to generate flash pattern 170 based, at least in part, upon computer address 156 (e.g., an IP address) of user computer 140 and a current time, such that flash pattern 170 is unique to concurrent login attempts within a defined period (e.g., ten-minutes, one hour, etc.). In block 408, process 400 generates a 2D barcode with an ID corresponding to account 154 and flash pattern 170. In one example of block 408, authenticator 162 invokes ID generator 164 to generate 2D barcode 168 with a unique ID 165 based, at least in part, upon an identity (e.g., a name, username, email address, etc.) corresponding to account 154, as identified in authentication request 153 and flash pattern 170. For example, 2D barcode 168 may encode flash pattern 170 as a bit pattern, code value, or seed value, that may be decoded and used by application 130 and used to generate flash pattern 136. In block 410, process 400 displays the 2D barcode on a webpage for the computer. In one example of block 410, web server 151 includes 2D barcode 168 on webpage 152 that is displayed on computer screen 142 of user computer 140 at the received computer address. That is, the webpage 152 is specifically generated for viewing only on user computer 140.

In block 412, process 400 captures the 2D barcode via the camera of the mobile device and decodes the unique ID and flash pattern. In one example of block 412, application 130 controls camera 122 of mobile device 120, when appropriately positioned by user 102, to capture at least one image 134 of webpage 152 including 2D barcode 168. Application 130 processes images 134 to decode unique ID 138 and flash pattern 136 (e.g., a code or seed value used to generate the optical modulation defined by flash pattern) from 2D barcode 168, where flash pattern 136 corresponds to flash pattern 170. Particularly, application 130 receives 2D barcode 168 and flash pattern 170 via webpage 152, which is displayed only on computer screen 142.

In block 414, process 400 generates and outputs the flash pattern at the biometric scanner. In one example of block 414, application 130 generates and outputs an optical signal modulated based upon flash pattern 136 via optical output 125 near biometric sensor 124. In block 416, process 400 captures a biometric image and remitted flash pattern. In one example of block 416, application 130 may invoke authenticator 128 to control biometric sensor 124 to capture a biometric image of a biometric source presented to biometric sensor 124 (e.g., hashing the captured biometric image), and to concurrently (or immediately sequentially to) capture a remitted pattern 139 from the biometric source using optical sensor 126 in response to flash pattern 136.

In block 418, process 400 confirms identification of the biometric image on the mobile device. In one example of block 418, authenticator 128 may compare the hashed biometric image to a previously stored biometric hash corresponding to user 102 and generate authentic indication 129 to indicate that the user 102 presenting the biometric source is recognized/authentic. In certain embodiments, authentic indication 129 may be a Boolean value that is true only when (a) the biometric image is authenticated to user 102, and (b) a user ID 132, stored within mobile device 120 and corresponding to the authenticable user 102 matches a user ID corresponding to account 154 that is received within 2D barcode 168 via webpage 152. In certain embodiments, authentic indication 129 may also include user ID 132 (e.g., a name, a user ID, or another unique alphanumerical code) as stored within mobile device 120 is association with user 102. However, authentic indication 129 does not include biometric images or data.

In block 420, process 400 sends the unique ID, the confirmation of the biometric identification, and the remitted flash pattern to an authentication server. In one example of block 420, application 130 generates message 133 to include unique ID 138, authentic indication 129, and remitted pattern 139, and sends message 133 to authenticator 162. In another example of block 420, application 130 generates message 133 to include unique ID 138, authentic indication 129 with an associated user ID 132, and remitted pattern 139, and sends message 133 to authenticator 162. Again, biometric data is not sent to the authenticator and is not accessible on the mobile device. In embodiments, application 130 may encrypt at least part of message 133 by using a public key of authenticator 162 for example, or by adding a code value, or by modifying remitted pattern 139 based upon a code value. Advantageously, this allows authenticator 162 to detect an attempted scam that simply returns the detected flash pattern 168 from webpage 152 and thereby not authenticate the scammer. For example, application 130 may receive an updated code value, at intervals (e.g., weekly), from authenticator 162, thereby further increasing security of the passwordless authentication provided by system 100.

In block 422, process 400 determines authentication of the user based upon the unique ID, the biometric ID confirmation, and the remitted flashing pattern. In one example of block 422, authenticator 162 sends an authentication message 172, indicating that user 102 is authenticated (e.g., validated) to account 154, to remote computer 150 only when each of the following conditions are true: (a) unique ID 138 received from application 130 matches unique ID 165 of the generated 2D barcode 168, (b) authentic indication 129 indicates that user 102 has been successfully authenticated by mobile device 120, and (c) the remitted pattern 139 matches flash pattern 170. By matching remitted pattern 139 to flash pattern 170, authenticator 162 ensures that the presented biometric source (e.g., fingerprint or face) occurred at the time when user 102 was requesting access, via webpage 152, to account 154, since flash pattern 170 is uniquely generated and displayed via webpage 152 on computer screen 142 during the access attempt. That is, subsequent access attempts, or access attempts using a different computer, would result in flash pattern 170 being different, and therefore the access to account 154 would not be granted. Thus, user authentic indicator 129 can be recorded and resubmitted, but must be captured with each new biometric authentication.

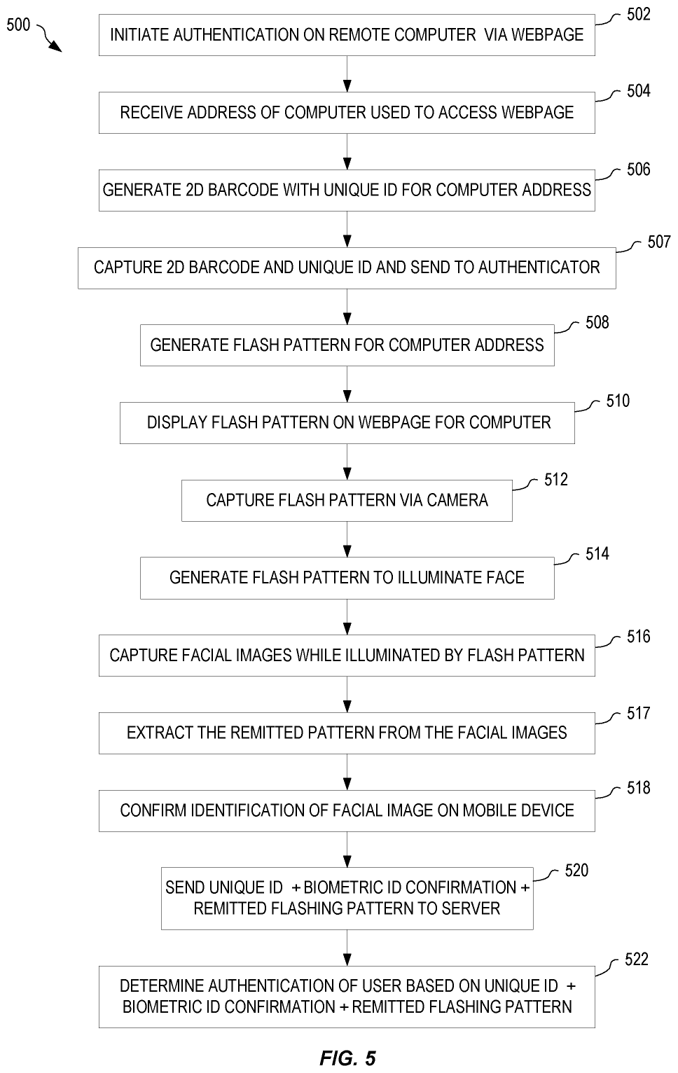

FIG. 5 illustrates one example passwordless authentication process 500 for authenticating, through face recognition and processing of a flashing pattern, a user seeking access to information and/or functionality via a webpage on a remote computer. Process 500 is similar to process 300 except that the fingerprinting is replaced by face (or iris) recognition as the biometric identification mechanism, and the flashing pattern is remitted off of the face. Process 500 is implemented, at least in part, in authenticator 162 and in application 130 running on mobile device 120. For example, blocks 504-508 and 522 may be implemented by authenticator 162; and block 512-520 may be implemented by application 130.

In block 502, process 500 initiates authentication on a remote computer via a webpage. In one example of block 502, user 102 initiates authentication on remote computer 150 via webpage 152 displayed on computer screen 142 of user computer 140. In block 504, process 500 receives an address of the computer used to access the webpage. In one example of block 504, web server 151 determines computer address 156 (e.g., an IP address) of user computer 140 based upon access to webpage 152, and web server 151 sends computer address 156, and optionally a user ID corresponding to account 154, as authentication request 153, to authenticator 162.

In block 506, process 500 generates a 2D barcode with a unique ID for computer address. In one example of block 506, authenticator 162 invokes ID generator 164 to generate, based, at least in part, upon computer address 156 2D barcode 168 with unique ID 165, as identified in authentication request 153. In block 507, process 500 captures the 2D barcode and unique ID and sends them to the authenticator. In one example of block 707, application 130 uses camera 122 to capture an image of computer screen 142 displaying 2D barcode 168, decodes unique identifier 138 from 2D barcode 168 and then sends a message 131 containing unique ID 138 to authenticator 162.

In block 508, process 500 generates a flashing pattern for the computer address. In one example of block 508, in response to authentication request 153, authenticator 162 invokes pattern generator 166 to generate flash pattern 170 based, at least in part, upon computer address 156 (e.g., an IP address) of user computer 140 and a current time, such that flash pattern 170 is unique to any other concurrent login attempts within a defined period (e.g., ten-minutes, one hour, etc.). In block 510, process 500 displays the flash pattern on a webpage for the computer. In one example of block 510, web server 151 includes flash pattern 170 on webpage 152 that is displayed on computer screen 142 of user computer 140 at the received computer address. That is, the webpage 152 may be specifically generated for viewing only on user computer 140.

In block 512, process 500 captures the flashing pattern via the camera of the mobile device. In one example of block 512, application 130 controls camera 122 of mobile device 120, when appropriately positioned by user 102, to capture a plurality of images 134 of webpage 152 including flash pattern 170. Application 130 processes images 134 to decode unique ID 138 from 2D barcode 168 and determine flash pattern 136, where flash pattern 136 corresponds to flash pattern 170. Particularly, application 130 receives 2D barcode 168 and flash pattern 170 via webpage 152, which is displayed only on computer screen 142.

In block 514, process 500 generates the flash pattern to illuminate the face of the user. In one example of block 514, application 130 outputs flash pattern 136 via a flash of camera 122, where camera 122 represent a rearward facing camera of mobile device 120. In another example of block 514, application 130 outputs flash pattern 136 via a display screen of mobile device 120, where camera 122 represent a forward-facing camera of mobile device 120. In block 516, process 500 captures facial images while illuminated by flash pattern. In one example of block 516, application 130 controls camera 122 to capture images 134 (e.g., a video) of face 106 of user 102 while face 106 is illuminated by flash pattern 136. In block 517, process 500 extracts the remitted pattern from the facial images. In one example of block 517, application 130 processes images 134 to extract remitted pattern 139, where remitted pattern 139 does not contain biometric information. By using these same images 134 for both authentication of user 102 and for determining remitted pattern 139, it is advantageously not possible to fool process 500 by using previously captured facial images.

In block 518, process 500 confirms identification of the facial image on the mobile device. In one example of block 518, authenticator 128 may compare the facial image to securely stored biometric data of user 102 and generate authentic indication 129 to indicate that facial image(s) is of user 102. In certain embodiments, authentic indication 129 may be a Boolean value that is true only when (a) the facial image is authenticated to user 102, and (b) a user ID 132, stored within mobile device 120 and corresponding to the authenticable user 102 matches a user ID received within 2D barcode 168 via webpage 152. In certain embodiments, authentic indication 129 may also include user ID 132 (e.g., a name, a user ID, or another unique alphanumerical code) of user 102 as stored within mobile device 120. However, authentic indication 129 does not include the biometric image.

In block 520, process 500 sends the unique ID, the confirmation of the biometric identification, and the remitted flash pattern to an authentication server. In one example of block 520, application 130 generates message 133 to include unique ID 138, authentic indication 129, and remitted pattern 139, and sends message 133 to authenticator 162. In another example of block 520, application 130 generates message 133 to include unique ID 138, authentic indication 129 with user ID 132, and remitted pattern 139, and sends message 133 to authenticator 162. It is noted that the biometric image is not sent to the authenticator and is not accessible on the mobile device. In certain embodiments, application 130 may encrypt at least part of message 133 by using a public key of authenticator 162 for example, or by adding a code value, or by modifying remitted pattern 139 based upon a code value. Advantageously, this allows authenticator 162 to detect an attempted scam that simply returns the detected flash pattern 168 from webpage 152 and thereby not authenticate the scammer. For example, application 130 may receive an updated code value, at intervals (e.g., weekly), from authenticator 162, thereby further increasing security of the passwordless authentication provided by system 100.

In block 522, process 500 determines authentication of the user based upon the unique ID, the biometric ID confirmation, and the remitted flashing pattern. In one example of block 522, authenticator 162 sends an authentication message 172 to remote computer 150, indicating that user 102 is authenticated (e.g., validated) to account 154, only when each of the following conditions is true: (a) unique ID 138 matches unique ID 165 of generated 2D barcode 168, (b) authentic indication 129 indicates that user 102 has been successfully authenticated by mobile device 120, and (c) the remitted pattern 139 matches flash pattern 170. By matching remitted pattern 139 to flash pattern 170, authenticator 162 ensures that the presented biometric source (e.g., the face 106 of user 102 in this embodiment) occurred at the time when user 102 was requesting access, via webpage 152, to account 154, since flash pattern 170 is uniquely generated and displayed via webpage 152 on computer screen 142 during the access attempt. That is, subsequent access attempts, or access attempts using a different computer, would result in flash pattern 170 being different, and therefore the access to account 154 would not be granted. Thus, user authentic indicator 129 can be recorded and resubmitted, but must be captured with each new biometric authentication.

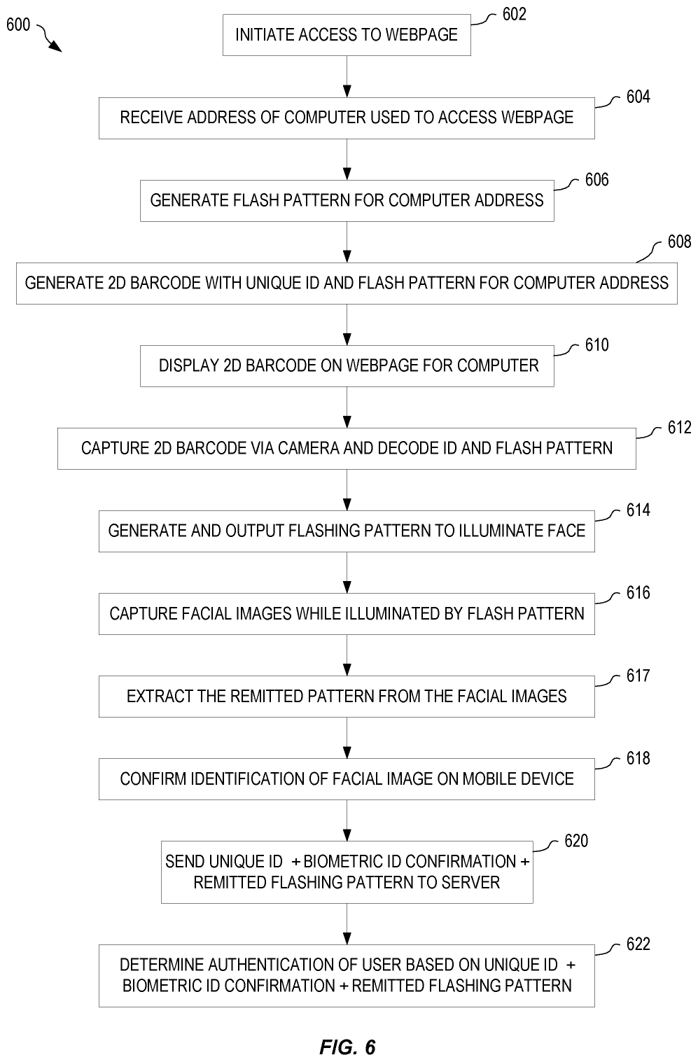

FIG. 6 illustrates another exemplary passwordless authentication process 600 for authenticating, through face recognition and processing of a flashing pattern, a user seeking access to information and/or functionality via a webpage on a remote computer. Process 600 is similar to process 500 of FIG. 5 except that the flashing pattern is not displayed on the computer screen, but instead encoded in the 2D barcode. Process 600 is implemented, at least in part, in authenticator 162 and in application 130 running on mobile device 120. For example, blocks 604-608 and 622 may be implemented by authenticator 162; and block 612-620 may be implemented by application 130.

In block 602, process 600 initiates access to a webpage. In one example of block 602, user 102 displays webpage 152 of remote computer 150 on computer screen 142 of user computer 140. In block 604, process 600 receives an address of the computer used to access the webpage. In one example of block 604, web server 151 determines computer address 156 (e.g., an IP address) of user computer 140 based upon access to webpage 152, and web server 151 sends computer address 156, and optionally a user ID corresponding to account 154, as authentication request 153, to authenticator 162.

In block 606, process 600 generates a flashing pattern for the computer address. In one example of block 606, in response to authentication request 153, authenticator 162 invokes pattern generator 166 to generate flash pattern 170 based, at least in part, upon computer address 156 (e.g., an IP address) of user computer 140 and a current time, such that flash pattern 170 is unique to any other concurrent login attempts within a defined period (e.g., ten-minutes, one hour, etc.). In block 608, process 600 generates a 2D barcode with a unique ID and the flash pattern of step 606. In one example of block 608, authenticator 162 invokes ID generator 164 to generate 2D barcode 168 with unique ID 165 based, at least in part, upon computer address 156, as identified in authentication request 153 and a code corresponding to flash pattern 170. For example, 2D barcode 168 may encode flash pattern 170 as a bit pattern, code value, or seed value, that may be decoded and used by application 130 and used to generate flash pattern 136. In block 610, process 600 displays the 2D barcode on a webpage for the computer. In one example of block 610, web server 151 includes 2D barcode 168 on webpage 152 that is displayed on computer screen 142 of user computer 140 at the received computer address. That is, the webpage 152 is specifically generated for viewing only on user computer 140.

In block 612, process 600 captures the 2D barcode via the camera of the mobile device and decodes the unique ID and flash pattern. In one example of block 612, application 130 controls camera 122 of mobile device 120, when appropriately positioned by user 102, to capture at least one image 134 of webpage 152 including 2D barcode 168. Application 130 processes the at least one image 134 to decode unique ID 138 and flash pattern 136 from 2D barcode 168, where unique ID 138 corresponds to unique ID 165 and flash pattern 136 corresponds to generated flash pattern 170. Particularly, application 130 receives 2D barcode 168 via webpage 152, which is displayed only on computer screen 142.

In block 614, process 600 generates and outputs the flash pattern to illuminate the face of the user. In one example of block 614, application 130 generates and outputs flash pattern 136 via a flash of camera 122, where camera 122 represent a rearward facing camera of mobile device 120. In another example of block 614, application 130 generates and outputs flash pattern 136 via display 127 of mobile device 120, where camera 122 represent a forward-facing camera of mobile device 120. Other dedicated output devices and/or components of mobile device 120 may be used to project flash pattern 136 onto face 106 of user 102 without departing from the scope hereof. In block 616, process 600 captures facial images while the face is illuminated by the flash pattern. In one example of block 616, application 130 controls camera 122 to capture images 134 (e.g., a video) of face 106 of user 102 while face 106 is illuminated by flash pattern 136. In block 617, process 600 extracts the remitted pattern from the facial images. In one example of block 617, application 130 processes images 134 to extract remitted pattern 139, where remitted pattern 139 does not contain any biometric information. By using these same images 134 for both authentication of user 102 and for determining remitted pattern 139, it is not possible to fool process 600 by using previously captured facial images. More than one camera may be used to capture the facial images and the remitted pattern without departing from the scope hereof.

In block 618, process 600 confirms identification of the facial image on the mobile device. In one example of block 618, authenticator 128 may compare the facial image 134 to securely stored biometric data of user 102 and generate authentic indication 129 to indicate whether the at least one facial image 134 is of user 102. In certain embodiments, authentic indication 129 may be a Boolean value that is true only when (a) the facial image is authenticated to user 102, and (b) a user ID 132, stored within mobile device 120 and corresponding to the authenticable user 102 matches a user ID associated with account 154 that is received within 2D barcode 168 via webpage 152. In certain embodiments, authentic indication 129 may also include user ID 132 (e.g., a name, a user ID, or another unique alphanumerical code) of user 102 as stored within mobile device 120. However, authentic indication 129 does not include any biometric images (e.g., image 134).

In block 620, process 600 sends the unique ID, the confirmation of the biometric identification, and the remitted flash pattern to an authentication server. In one example of block 620, application 130 generates message 133 to include unique ID 138, authentic indication 129, and remitted pattern 139, and sends message 133 to authenticator 162. In another example of block 620, application 130 generates message 133 to include unique ID 138, authentic indication 129 with user ID 132, and remitted pattern 139, and sends message 133 to authenticator 162. It is noted that the biometric image is not sent to the authenticator and is not accessible on the mobile device. In embodiments, application 130 may encrypt at least part of message 133 by using a public key of authenticator 162 for example, or by adding a code value, or by modifying remitted pattern 139 based upon a code value. Advantageously, this allows authenticator 162 to easily detect an attempted scam that simply returns the detected flash pattern 168 from webpage 152 and thereby not authenticate the scammer. For example, application 130 may receive an updated code value, at intervals (e.g., weekly), from authenticator 162, thereby further increasing security of the passwordless authentication provided by system 100.

In block 622, process 600 determines authentication of the user based upon the unique ID, the biometric ID confirmation, and the remitted flashing pattern. In one example of block 622, authenticator 162 sends an authentication message 172, indicating that user 102 is authenticated (e.g., validated) to account 154, to remote computer 150 only when each of the following conditions is true: (a) unique ID 138 received from application 130 matches unique ID 165 of 2D barcode 168, (b) authentic indication 129 indicates that user 102 has been successfully authenticated by mobile device 120, and (c) the remitted pattern 139 matches flash pattern 170. By matching remitted pattern 139 to flash pattern 170, authenticator 162 ensures that the face was authenticated at the time user 102 requested access, via webpage 152, to account 154, since flash pattern 170 is uniquely generated and transferred to mobile device 140 via webpage 152 on computer screen 142 during the access attempt. That is, subsequent access attempts, or access attempts using a different computer, would result in flash pattern 170 being different, and therefore the access to account 154 would not be granted. Thus, user authentic indicator 129 can be recorded and resubmitted, but must be captured with each new biometric authentication.

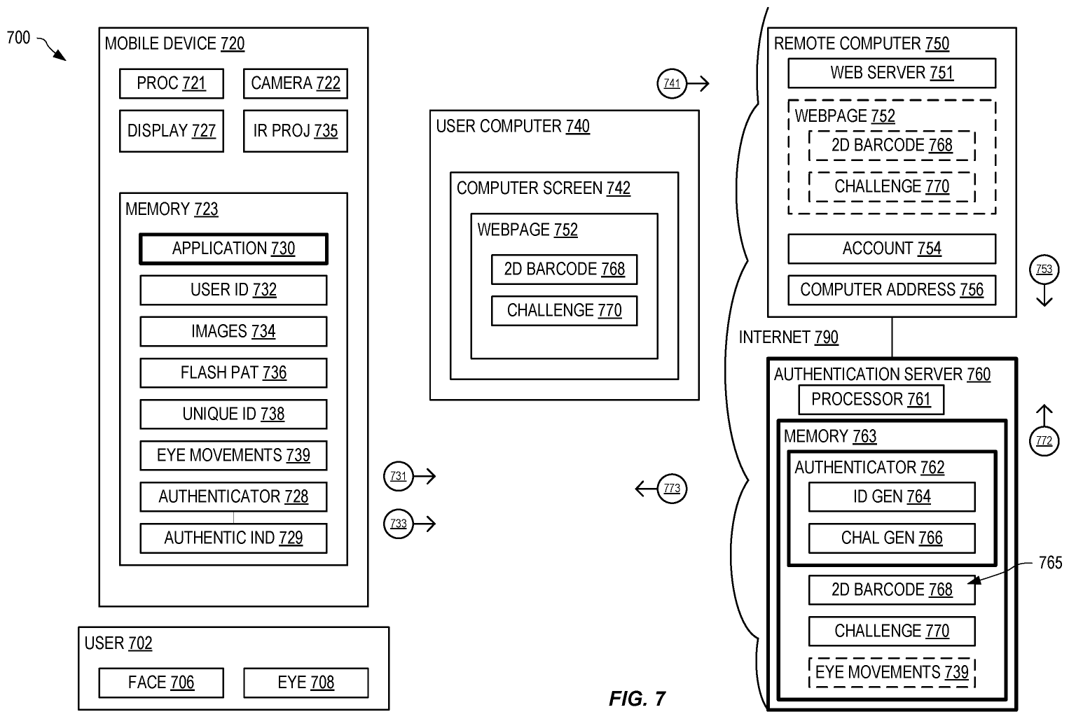

FIG. 7 illustrates one example system passwordless authentication system 700. System 700 is similar to system 100 of FIGS. 1 and 2, using facial recognition of a user, but rather than using a flash pattern (e.g., flash pattern 170), system 700 detects eye movement of the user in response to a challenge command presented via a webpage. This embodiment advantageously uses facial recognition performed by a mobile device of the user such that biometric information is not stored or transferred to the authentication server.

A user 702 is required to provide authentication when using a user computer 740 (e.g., local to the user), running a web browser for example, to access an account 754 of a remote computer 750 via the Internet 790 for example. Account 754 is not limited to any particular account based functionality, and may represent any information that is securely accessible via a web server 751 running on remote computer 750. In one example of operation, in response to interaction by user 702, user computer 740 accesses a webpage 752 of remote computer 750 (e.g., to access an account 754). Remote computer 750 may send a computer address 756 (e.g., an IP address) of user computer 740 to an authenticator 762 running in an authentication server 760. In certain embodiments, remote computer 750 and authentication server 760 may be the same server that implements both web server 751 and authenticator 762. Web server 751 may cooperate with authenticator 762 to generate a webpage 752 including a two-dimensional barcode (2D barcode) 768 with a unique ID 765 for display by user computer 740. 2D barcode 768 is for example a graphically encoded value that includes unique ID 765 that is unique to computer address 756. A data depth of 2D barcode 768 allows for the encoded information to be unique to each instance of process 700, at least for a certain time interval (e.g., at least ten minutes or at least an hour). That is, 2D barcode 768 is unique to authenticator 762 for this authentication attempt via user computer 740.

User 702 has a mobile device 720 (e.g., a smartphone or similar device), that runs an application 730 (e.g., a downloadable device “app”) associated with authenticator 762. Mobile device 720 is capable of biometric authentication (e.g., one or more of fingerprint authentication, facial recognition, iris recognition, etc.), and may authenticate user 702 to mobile device 720 without sending biometric data to other devices. Mobile device 720 may communicate with authenticator 762 via a local area network and/or Internet 790 for example, based upon information (e.g., a URL) included within 2D barcode 768; however, mobile device 720 may use other communication paths (e.g., cellular) without departing from the scope hereof.

User 702 may initiate application 730, or, in certain embodiments, authenticator 762 may initiate application 730 (described in more detail below) in response to capturing 2D barcode 768 from computer screen 742. For example, user 702 may control mobile device 720 to capture, using camera 722, an image of computer screen 742 including 2D barcode 768. Application 730 may then decode 2D barcode 768 to determine unique ID 738, and then send a message 731 including unique ID 738 to authenticator 762 to initiate authentication. In response, authenticator 762 may generate challenge command 770.

Challenge command 770 may represent instructions for user 702 to follow during authentication. For example, application 730 may include one or more algorithms to process images from camera 722 to determine evidence of eye movement 739 as user 702 follows challenge command 770 immediately prior to, during, or immediately after, authentication. Application 730 simultaneously biometrically authenticates user 702 with mobile device 720 and captures evidence, based upon a response by user 702 to a challenge command 770, that user 702 is near user computer 740 and that the authentication is in response to the requested access to account 754.

Application 730 then sends a message 733 to authenticator 762 indicating (a) success or failure of the biometric authentication of user 702, whether the identity defined by 2D barcode 768 matches an identity stored within mobile device 720 of user 702, and the captured evidence (e.g., the detected eye movement 739). Authenticator 762 processes message 731 to authenticate user 702 for accessing account 754. For example, where message 731 indicates (a) that mobile device 702 successfully authenticated user 702, and (b) that the user name defined by 2D barcode 768 matches the stored identity of user 702 within mobile device 702, and where the captured evidence (e.g., eye movement) follows challenge command 770, authenticator 762 may determine that user 702 is authenticated (e.g., validated) for accessing account 754, and may notify web server 751 of remote computer 750 accordingly. In embodiments, application 730 may encrypt at least part of message 733 by using a public key of authenticator 762 for example, or by adding a code value, or by modifying eye movement 739 based upon a code value. Advantageously, this allows authenticator 762 to easily detect an attempted scam that simply returns the detected flash pattern 768 from webpage 752 and thereby not authenticate the scammer. For example, application 730 may receive an updated code value, at intervals (e.g., weekly), from authenticator 762, thereby further increasing security of the passwordless authentication provided by system 700.

Advantageously, the use of 2D barcode 768, challenge command 770, and local biometric authentication by mobile device 720, allows authenticator 762 to authenticate user 702 without requiring a password to be input, and without biometric images being transmitted from mobile device 702. Particularly, user 702 is biometrically identified by mobile device 702, and evidence indicates that user 702 is present at user computer 740 during the authentication and when user computer 740 is being used to access account 754.

Mobile device 720 may represent a smartphone or similar type device that includes a processor 721, a camera 722, and a memory 723. Application 730 is for example a downloadable “app” that includes machine readable instructions that may be downloaded to memory 723 and executed by processor 721 to provide secure communication and cooperation between mobile device 720 and authenticator 762 as described herein. Mobile device 720 may include an authenticator 728 (e.g., software that implements the user authentication using camera 722 without storing or transmitting any captured biometric images). Authenticator 728 is for example an integrated part of mobile device 720 (e.g., a service provided by mobile device 720) that generates an authentic indication 729 based upon authenticating a facial image of the user to a securely stored biometric information. Authenticator 728 may also generate a liveness parameter associated with a facial image.

User computer 740 is for example a computing device that includes a processor and memory (not shown) that cooperate to run a web browser (e.g., software) that allows user 702 to interact with webpage 752 displayed on a computer screen 742 of user computer 740. User computer 740 may represent one or more of a desktop computer, a laptop computer, a tablet computer, and so on.

Remote computer 750 is for example a cloud based computing device that is accessible via the Internet 790 and includes a processor and a memory (not shown). Remote computer 750 may implement a web server 751 that provides web services and web access to information, such as account 754. Web server 751 may implement webpage 752 and interact with user computer 740 (via the Internet 790) and with authenticator 762 (e.g., via the Internet 790 and/or other LANs or computer networks). In one example of operation, web server 751 may receive request message 741 from user computer 740, and, in response, generate and send an authentication request 753, containing at least computer address 756 (e.g., an IP address) of user computer 740 and optionally a user ID entered by user 702 to user computer 740, to authenticator 762.

Authentication server 760 includes at least one processor 761 and memory 763 that stores authenticator 762 as machine readable instructions that, when executed by processor 761, implement functionality of authenticator 762 as described herein. Authenticator 762, running on authentication server 760, may provide authentication as a service to remote computer 750 and/or user 702. Based, at least in part, upon computer address 756 within authentication request 753, authenticator 762 invokes a challenge generator 766 to generate challenge command 770 that may be unique to user computer 740 within a current time window. In certain embodiments, in response to authentication request 753, authenticator 762 may also generate and send an activation message 773 (e.g., a notification) to mobile device 720 to initiate application 730. For example, authenticator 762 may look-up an address (e.g., an IP address, phone number, email address) of mobile device 720 based upon one or both of the user ID and computer address 756 received in authentication request 753. In another example, authenticator 762 may receive, in response activation message 773, an acknowledgement 733 from application 730 that include a user ID of user 702 stored on mobile device 702, thereby automatically determining the user ID such that user 702 need not enter it to webpage 752. In another example, auto-fill functionality of the browser running on user computer 740 may automatically provide the user ID of user 702. Authenticator 762 may invoke an ID generator 764 to generated 2D barcode 768 with unique ID 765 based upon one or both of the computer address 756, the user ID included within authentication request 753 and/or received from application 730. In one example, ID generator 764 generates 2D barcode 768 as a QR code that may be displayed in webpage 752 and read, using camera 722, by application 730. In another example, ID generator 764 generates 2D barcode 768 as a bar code that may be similarly read by application 730.

A user 702 is shown with a face 706 (e.g., for facial biometric authentication), and an eye 708 (e.g., for determining compliance with challenge command 770).

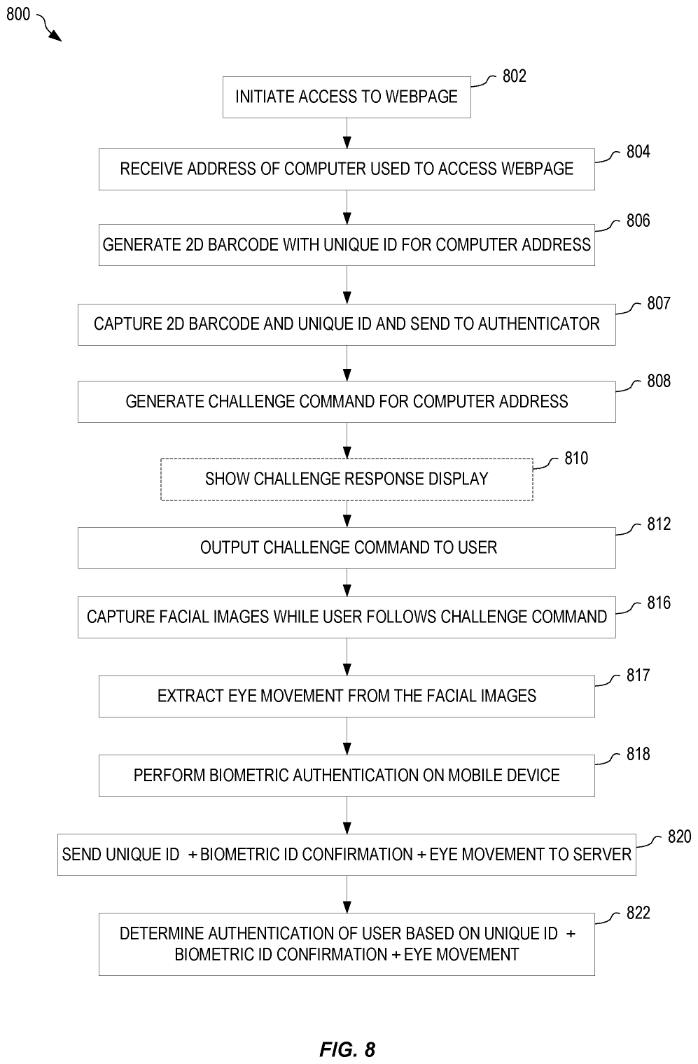

FIG. 8 illustrates one exemplary passwordless authentication process 800 for authenticating, through face recognition and eye tracking, a user seeking access to information and/or functionality via a webpage on a remote computer. Process 800 involves (a) a server (e.g., authenticating server 760), (b) a remote computer (e.g., remote computer 750) through which the user, once authenticated, may exercise the granted access, and (c) a mobile device (e.g., mobile device 720) equipped with a camera, a display, and an application (e.g., a downloadable device “app” such as application 730). Process 800 is for example implemented, at least in part, in authenticator 762 and in application 730 running on mobile device 720. Blocks 804-808 and 822 may be implemented by authenticator 762; and block 812-820 may be implemented by application 730.

In block 802, process 800 initiates access to a webpage. In one example of block 802, user 702 initiates access to webpage 752 displayed on user computer 740. In block 804, process 800 receives the address of the user computer used to access the webpage. In one example of block 804, remote computer 750 (e.g., web server 751) determines computer address 756 (e.g., an IP address) of user computer 740 and communicates computer address 756 to authentication server 760 as authentication request 753.

In block 806, process 800 generates 2D barcode with a unique ID for the computer address. In one example of block 806, authenticator 762 invokes ID generator 764 to generate 2D barcode 768 with unique ID 765 for computer address 756 and authenticator 762 sends 2D barcode 768 to web server 751 for display on webpage 752.

In block 807, process 800 captures the 2D barcode and unique ID and sends them to the authenticator. In one example of block 807, application 730 uses camera 722 to capture an image of computer screen 742 displaying 2D barcode 768, decodes unique identifier 738 from 2D barcode 768, and then sends a message 731 containing unique ID 738 to authenticator 762, based upon an address (e.g., a URL) in 2D barcode 768.

In block 808, process 800 generates a challenge command for the computer address. In one example of block 808, authenticator 762 invokes challenge generator 766 to generate challenge command 770, based at least in part upon computer address 756 for example. In another example of block 808, authenticator 762 invokes challenge generator 766 to randomly generate challenge command 770. Block 810 is optional. If included, in block 810, process 800 shows a challenge response display. In one example of block 810, application 730 displays, on a display 727 of mobile device 720, a challenge response display including spatially arranged visual items that user 702 may look at when following the challenge command 770. In certain embodiments, application 730 is preconfigured to display the challenge response display of spatially arranged visual items on display 727 when needed. In certain embodiments, 2D barcode 768 may indicate to application 730 when challenge response display is needed.

In block 812, process 800 outputs the challenge command to the user. In one example of block 812, authenticator 762 sends challenge command 770 to web server 751, and web server 751 includes challenge command 770 on webpage 752 for display on computer screen 742 to user 702. In another example of block 812, challenge command 770 is sent to application 730 running on mobile device 720 for output to user 702.

In one example of operation, challenge command 770 instructs user 702 to look at certain items shown on display 727 of mobile device 720. For example, mobile device 720 shows challenge response display (of block 810) as a grid of different images, letter, digits, or other identifiable items, on display 727 and challenge command 770, displayed on computer screen 742 instructs user 702 to look at certain of these identifiable items in a defined order. In another embodiment, no particular challenge response display is shown, but challenge command 770 instructs user 702 to look at certain locations on mobile device 720 in a specific order (e.g., upper right corner, lower right corner, center, lower left corner). In another example of block 814, in response to instructions within 2D barcode 768, application 730 generates and displays both the challenge response display and challenge command 770 on display 727 of mobile device 720. In yet another embodiment, application 730 shows challenge response display on display 727 and outputs challenge command 770 as audible instructions for user 702 to follow, for example by audibly instructing the user to look at certain items on display 727 in a certain order, where the order is encoded within 2D barcode 768.

In block 816, process 800 captures facial images as the user follows the challenge command. In one example of block 816, application 730 controls camera 722 to capture a sequence of images 734 of face 706 as user 702 follows challenge command 770. In block 817, process 800 extracts eye movement from the facial images. In one example of block 817, application 730 processes images 734 to determine eye movement 739 of user 702 while following challenge command 770. Eye movement 739 is, for example, a sequence of angular eye movement directions and distances and does not contain identifying biometric images of user 702. In certain embodiments, application 730 may interface with an eye tracking module that determines eye movement of user 702 via camera 722. In block 818, process 800 performs biometric authentication on the mobile device. In one example of block 818, application 730 invokes authenticator 728 to process at least one of images 734 to authenticate user 702 using one or both of face recognition and iris recognition. In one example of block 818, authenticator 728 may compare facial image 734 to a previously captured and securely stored facial image corresponding to user 702 and generate authentic indication 729 to indicate that the known user 702 is presenting the facial image. In certain embodiments, authentic indication 729 may be a Boolean value that is true only when (a) the facial image 734 is authenticated to user 702, and (b) a user ID 732, stored within mobile device 720 and corresponding to the authenticable user 702 matches a user ID corresponding to account 754 received within 2D barcode 768 via webpage 752. In certain embodiments, authentic indication 729 may also include user ID 732 (e.g., a name, a user ID, or another unique alphanumerical code) of authenticable user 702 as stored within mobile device 720. However, authentic indication 729 does not include the facial image.

Blocks 817 and 818, when using the same captured images 734, implement concurrent recognition and eye tracking. In certain embodiments, where two sets of images are captured for each of facial recognition and eye movement detection, these images are captured sufficiently close in time to ensure that the same face recognized in block 818 carried out challenge command 770 detected in block 817.

In block 820, process 800 sends the unique ID, the biometric ID confirmation, and the eye movement to the authentication server. In one example of block 820, application 730 sends a message 731 to authenticator 762 including unique ID 738, authentic indication 729, and detected eye movement 739, where authentic indication 729 is true when (a) the facial image 734 is authenticated to user 702, and (b) a user ID 732, stored within mobile device 720 matches a user ID corresponding to account 754 that is received within 2D barcode 768 via webpage 752. In another example of block 820, application 730 sends message 731 to authenticator 762 including unique ID 738, authentic indication 729 with user ID 732, and detected eye movement 739. However, message 731 does not include biometric data (face or eye), since eye movements 739 includes eye tracking data and not images of the user's face or eye(s).

Authentic indication 729 and eye movements 739 provides evidence that ensures (or at least raises confidence) that face 706 of user 702 was present while authentication took place, and that the face-recognition-based user identity was not based upon, e.g., a previously captured image. Where authentication and eye tracking occurred separately (e.g., not using the same images 734), application 730 may ask mobile device 720 to confirm that authentication and eye tracking were sufficiently close together to ensure that the same face was used for both.

In block 822, process 800 determines authentication of user based on unique ID, biometric ID confirmation, and eye movement. In one example of block 822, authenticator 862 sends an authentication message 772, indicating that user 702 is authenticated (e.g., validated) to account 754, to remote computer 750 only when each of the following conditions is true: (a) unique ID 738 received from application 730 matches unique ID 765 of 2D barcode 768, (b) authentic indication 729 indicates that user 702 has been successfully authenticated by mobile device 720, and (c) the eye movements 739 follow challenge command 770. By matching eye movements 739 to challenge command 770, authenticator 762 ensures that the face was authenticated at the time user 702 requested access, via webpage 752, to account 754, since challenge command 770 is uniquely generated and transferred via webpage 752 during the access attempt. Access attempts that do not follow the presented challenge command 770 do not result in access to account 754. Thus, recording and resubmitting authentic indicator 729 and/or eye movements 739 will not result in access to account 754.

In one embodiment, eye movement is not detected, and instead, user 702 provides an input, or series of inputs, (e.g., selecting items on display 727) in response to challenge command 770. In another embodiment, challenge response display is included in webpage 752 and shown on computer screen 742 (instead of on display 727), and challenge command 770 is output on display 727 (or output audibly) of mobile device 720. In this embodiment, user 702 provides input to user computer 740 when following challenge command 770 and these inputs are sent to authenticator 762, which verifies that user 702 has correctly followed challenge command 770. In another embodiment, where user computer 740 includes a camera, user computer 740 may detect eye movement as user 702 follows challenge command 770. For example, user computer 740 may accepts an input, or series of inputs, from user 702 via a keyboard, mouse, and/or other input device, in response to challenge command 770 and display of the challenge response display on computer screen 742.

In these example, application 730 captures expected eye movements 739 in response to challenge command 770. However, other movements may be commanded and detected by system 700 without departing from the scope hereof. For example, where authentication is based upon facial recognition, challenge command 770 may instruct user to blink during the facial authentication. Accordingly, application 730 may process images 734 to detect eyes 708 of user 702 blinking. In another example, challenge command 770 may instruct user to move their head during the facial authentication. Accordingly, application 730 may process images 734 to detect head movement of user 702. The detected facial movement may include one or more of blinking, smiling, speaking, mouthing (moving the mouth to make certain shapes), head tilting, head shaking, nodding, yawning, and so on.

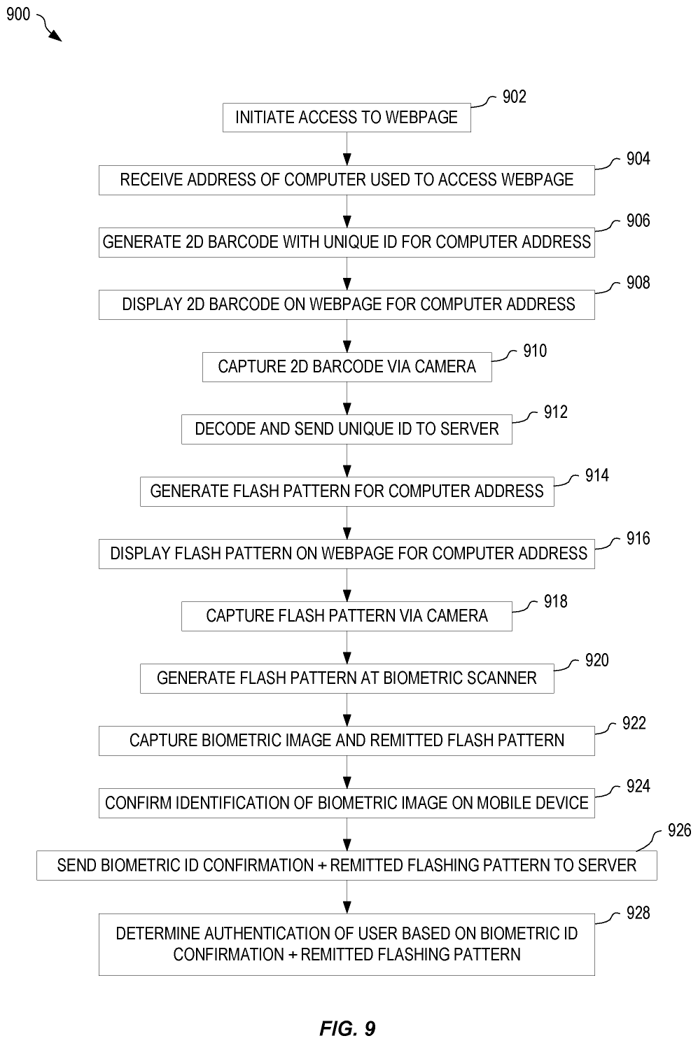

FIG. 9 is a flowchart illustrating an alternative passwordless authentication process 900 for authenticating, through fingerprint and flash pattern remittance, a user seeking access to account 154 (e.g., information and/or functionality) at remote computer 150 via webpage 152 and user computer 140 as shown in FIGS. 1 and 2. For clarity of illustration, process 900 implements fingerprint recognition and flash pattern verification, but process 900 may also implement facial recognition and challenge command verification; accordingly, process 900 is similar to process 300 of FIG. 3, but differences between process 900 and process 300 may also be implemented for processes 400, 500, 600, and 800 of FIGS. 4, 5, 6, and 8, respectively. In summary, these differences include completing communication of at least the unique ID 165 of 2D barcode 168 generated by authenticator 162, through webpage 152 displayed on computer screen 142, via camera 122 and application 130 of mobile device 120, and back to authenticator 162, before proceeding to display flashing pattern 170 on computer screen 142. Process 900 may be implemented, at least in part, in authenticator 162 and in application 130 running on mobile device 120. For example, blocks 904-908, 914-916, and 928 may be implemented by authenticator 162; and block 910-912 and 918-926 may be implemented by application 130.

In block 902, process 900 initiates access to a webpage. In one example of block 902, user 102 displays webpage 152 of remote computer 150 on computer screen 142 of user computer 140. In block 904, process 900 receives an address of the computer used to access the webpage. In one example of block 904, web server 151 determines computer address 156 (e.g., an IP address) of user computer 140 based upon access to webpage 152, and web server 151 sends computer address 156, as authentication request 153, to authenticator 162.

In block 906, process 900 generates a 2D barcode with a unique ID for the computer address. In one example of block 906, authenticator 162 invokes ID generator 164 to generate 2D barcode 168 with unique ID 165 based, at least in part, upon computer address 156, included within authentication request 153. In block 908, process 900 displays the 2D barcode on a webpage for the computer address. In one example of block 908, web server 151 includes 2D barcode 168 on webpage 152 that is displayed on computer screen 142 of user computer 140 at the received computer address 156. That is, the webpage 152 is specifically generated for viewing only on user computer 140.

In block 910, process 900 captures the 2D barcode via the camera of the mobile device. In one example of block 910, application 130 controls camera 122 of mobile device 120, when appropriately positioned by user 102, to capture at least one image 134 of webpage 152 including 2D barcode 168. Application 130 processes the at least one image 134 to decode unique ID 138 from 2D barcode 168. Accordingly, unique ID 138 corresponds to unique ID 165 to uniquely identify 2D barcode 168. Application 130 thereby receives 2D barcode 168 and unique ID 138 via webpage 152, which is displayed only on computer screen 142. In block 912, process 900 sends the unique ID to the server. In one example of block 912, application 130 sends unique ID 138 to authenticator 162 running on authentication server 160.

In block 914, process 900 generates a flashing pattern for the computer address. In one example of block 914, in response to matching unique ID 138 received from application 130 against unique ID 165 generated for 2D barcode 168, authenticator 162 invokes pattern generator 166 to generate flash pattern 170 based, at least in part, upon computer address 156 (e.g., an IP address) of user computer 140 and a current time, such that flash pattern 170 is unique compared to other concurrent login attempts within a defined period (e.g., ten-minutes, one hour, etc.). In block 916, process 900 displays the flash pattern on the web page for the computer address. In one example of block 916, web server 151 includes flash pattern 170 on webpage 152 that is displayed on computer screen 142 of user computer 140 at the received computer address 156.

In block 918, process 900 captures the flash pattern via the camera. In one example of block 918, application 130 controls camera 122 of mobile device 120, when appropriately positioned by user 102, to capture a plurality of images 134 of webpage 152 including flash pattern 170. Application 130 processes the plurality of images 134 to determine flash pattern 136 from webpage 152.

In block 920, process 900 generates the flash pattern at the biometric scanner. In one example of block 920, application 130 outputs flash pattern 136 via optical output 125 near biometric sensor 124. In block 922, process 900 captures a biometric image and remitted flash pattern. In one example of block 922, application 130 may invoke authenticator 128 to control biometric sensor 124 to capture a biometric image of a biometric source (e.g., fingerprint) presented to biometric sensor 124 (e.g., hashing the captured biometric image as needed), and to concurrently (or immediately sequentially to) capture, using optical sensor 126, a remitted pattern 139 from the biometric source in response to flash pattern 136.

In block 924, process 900 confirms identification of the biometric image on the mobile device. In one example of block 924, authenticator 128 may compare the hashed biometric image to a previously stored biometric hash corresponding to user 102 and generate authentic indication 129 to indicate that the known user 102 is presenting the biometric source. In certain embodiments, authentic indication 129 may be a Boolean value that is true only when (a) the biometric image is authenticated to user 102, and (b) a user ID 132, stored within mobile device 120 and corresponding to the authenticable user 102 matches a user ID corresponding to account 154 received within 2D barcode 168 via webpage 152. In certain embodiments, authentic indication 129 may also include a name, a user ID, or another unique alphanumerical code indicating an identity of authenticable user 102 as stored within mobile device 120. However, authentic indication 129 does not include the biometric image.

In block 926, process 900 sends the biometric identification confirmation and the remitted flash pattern to the authentication server. In one example of block 926, application 900 generates message 133 to include authentic indication 129 and remitted pattern 139, and sends message 133 to authenticator 162. In another example of block 926, application 130 generates message 133 to include authentic indication 129, user ID 132, and remitted pattern 139, and sends message 133 to authenticator 162. It is noted that no biometric images are sent to the authenticator and the biometric images are not accessible on the mobile device. In embodiments, application 130 may encrypt at least part of message 133 by using a public key of authenticator 162 for example, or by adding a code value, or by modifying remitted pattern 139 based upon a code value. Advantageously, this allows authenticator 162 to easily detect an attempted scam that simply returns the detected flash pattern 168 from webpage 152 and thereby not authenticate the scammer. For example, application 130 may receive an updated code value, at intervals (e.g., weekly), from authenticator 162, thereby further increasing security of the passwordless authentication provided by system 100.

In block 928, process 900 determines authentication of the user based upon the unique ID, the biometric ID confirmation, and the remitted flashing pattern. In one example of block 928, authenticator 162 sends an authentication message 172 to remote computer 150, indicating that user 102 is authenticated (e.g., validated) to account 154, only when each of the following conditions is true: (a) the unique ID 138 received from application 130 matches unique ID 165 of 2D barcode 168, (b) authentic indication 129 indicates that user 102 has been successfully authenticated by mobile device 120, and (c) that the remitted pattern 139 matches flash pattern 170. By matching remitted pattern 139 to flash pattern 170, authenticator 162 ensures that the presented biometric source (e.g., fingerprint) occurred at the time when user 102 was requesting access, via webpage 152, to account 154, since flash pattern 170 is uniquely generated and displayed via webpage 152 on computer screen 142 during the access attempt. That is, subsequent access attempts, or access attempts using a different computer, would result in flash pattern 170 being different, and therefore the access to account 154 would not be granted. Thus, user authentic indicator 129 cannot be recorded and resubmitted, but must be captured with each new biometric authentication.

### Reflective Oximeter

The combined fingerprint reader (e.g., biometric sensor 124, optical output, and optical sensor 126, see also WO 2019/032587, incorporated by reference above) of FIG. 2, as described above, may also implement a reflective oximeter that determines a photoplethysmogram (PPG) 178 (see FIG. 2) by illuminating the skin of finger 104 and measuring changes in light absorption. Similarly, camera 122 and infrared projector 135 (see also infrared projector 735 of FIG. 7) may also implement a reflective oximeter that determines PPG 178 by illuminating the skin of face 106 and measuring changes in light absorption. The determined PPG 178 may include waves that indicate an activity of user 102. For example, as user 102 takes a deep breath, stands, sits, coughs, changes respiration rate, and so on, waves within PPG 178 change in response to the activity. Advantageously, application 130 may output (e.g., visually via display 127 and/or audibly as spoken instruction) a challenge command (e.g., challenge command 770) to user 102/702 and capture PPG 178 and send it to authenticator 162 in place of remitted pattern 139, where PPG 178 shows changes in response to user 102 following the challenge command.

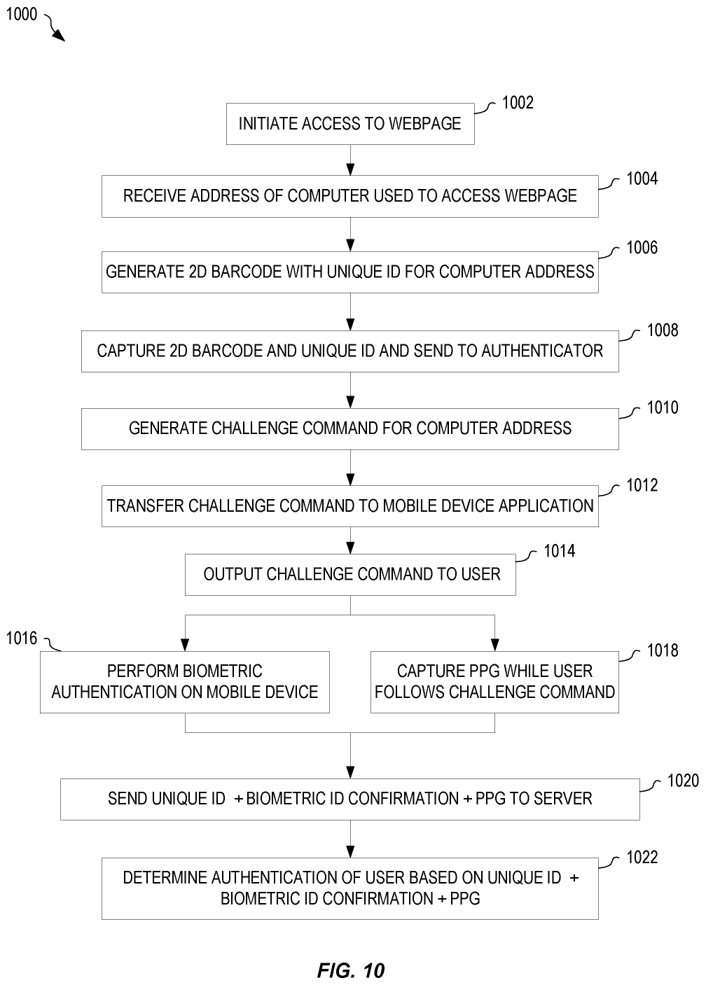

FIG. 10 is a flowchart showing one example process 1000 for passwordless authentication using PPG. Process 1000 may be implemented, at least in part, in authenticator 162 running on authentication server 160 and in application 130 running on mobile device 120. For example, blocks 1004-1006, 1010-1012, and 1022 may be implemented by authenticator 162; and blocks 1008, 1014-1020 may be implemented by application 130.

In block 1002, process 1000 initiates access to a webpage. In one example of block 1002, user 102 displays a webpage 152 of remote computer 150 on computer screen 142 of user computer 140. In block 1004, process 1000 receives an address of the computer used to access the webpage. In one example of block 1004, web server 151 determines computer address 156 (e.g., an IP address) of user computer 140 based upon access to webpage 152, and web server 151 sends computer address 156, and optionally a user ID corresponding to account 154, as authentication request 153, to authenticator 162.

In block 1006, process 1000 generates a 2D barcode with a unique ID for the computer address. In one example of block 1006, authenticator 162 invokes ID generator 164 to generate 2D barcode 168 with unique ID 165 based, at least in part, upon computer address 156. In block 1008, process 1000 captures the 2D barcode and unique ID and sends them to the authenticator. In one example of block 1008, application 130 uses camera 122 to capture an image of computer screen 142 displaying 2D barcode 168, decodes unique identifier 138 from 2D barcode 168 and then sends a message 131 containing unique ID 138 to authenticator 162.

In block 1010, process 1000 generates a challenge command for the computer address. In one example of block 1010, authenticator 762 invokes challenge generator 766 to generate challenge command 770, based at least in part upon computer address 756. In another example of block 1010, authenticator 762 invokes challenge generator 766 to randomly generate challenge command 770. In block 1012, process 1000 transfers the challenge command to the mobile device application. In one example of block 1012, authenticator 162 updates 2D barcode 168 to include the challenge command (e.g., as a code or encoded text) and displays the updated 2D barcode 168 on computer display 142 such that mobile device recaptures 2d barcode 168 using camera 122 to decode challenge command 770. In another example of block 1012, authenticator 162 sends the challenge command 770 to application 130 as a message. Other secure methods of transferring the challenge command from authenticator 162 to application 130 maybe used without departing from the scope hereof.

In block 1014, process 1000 outputs the challenge command to the user. In one example of block 1014, application 130 displays the challenge command on display 127 of mobile device 120. In another example of block 1014, application 130 may cause mobile device 120 to say, “place your finger over the fingerprint reader,” and after a short pause “take a deep breath.” In another example, of block 1014, application 130 may cause mobile device 120 to say, “stand up, then place your finger on the fingerprint reader, and then sit down.”

Blocks 1016 and 1018 may occur simultaneously, or very close together in time, and may overlap with block 1014. In block 1016, process 1000 performs a biometric authentication on the mobile device. In one example of block 1016, application 130 invokes local authenticator 128 to authenticate finger 104 using biometric sensor 124 and generates authentic indication 129. In block 1018, process 1000 captures a PPG while the user follows the challenge command. In one example of block 1018, application 130 controls optical output 125 and optical sensor 126 to capture PPG 178 as user follows the challenge commands output in block 1014. Advantageously, PPG 178 is captured simultaneously to authentication of finger 104, such that PPG 178 is known to be from finger 104 of user 102. Advantageously, this makes it very difficult, if not impossible, to spoof the fingerprint authentication and the capture of PPG 178.

In block 1020, process 1000 sends the unique ID, the biometric ID confirmation, and the captured PPG to the authentication server. In one example of block 1020, application 130 sends message 133 including unique ID 138, authentication ID 129, and to authenticator 162. In block 1022, process 1000 determines authentication of the user based on the unique ID, the biometric ID confirmation, and the PPG. In one example of block 1022, authenticator 162 sends an authentication message 172 to remote computer 150, indicating that user 102 is authenticated (e.g., validated) to account 154, only when each of the following conditions is true: (a) the unique ID 138 received from application 130 matches unique ID 165 generated for 2D barcode 168, (b) authentic indication 129 indicates that user 102 has been successfully authenticated by mobile device 120, and (c) that PPG 178 shows the expected response based upon the challenge command.

The encoded embodiments disclosed herein thus teach both passive passwordless biometric authentication, where the flash pattern generated by an authentication server is remitted from the user's finger or face during authentication of the user by a mobile device, and active passwordless biometric authentication, where a response of the user performing a challenge command generated by the authentication server during authentication of the user by the mobile device. Detected responses of the user during active passwordless biometric authentication may include physical movements, such as eye movement, head movement, etc., and/or detection of the user's response in reflective oximeter reading as the user follows the challenge command. Neither the passive passwordless biometric authentication or the active passwordless biometric authentication sends biometric data to the authentication server. However, by detecting the flash pattern or the user response to the challenge command, the presence of the user at the computer displaying the webpage is confirmed, such that the user can be authenticated to that webpage.

Features described above as well as those claimed below may be combined in various ways without departing from the scope hereof. The following examples illustrate possible, non-limiting combinations the present invention has been described above, it should be clear that many changes and modifications may be made to the process and product without departing from the spirit and scope of this invention:

(A) A passwordless authentication method includes: receiving a code from an authenticator; biometrically identifying a user by interrogating a body part of the user; concurrently with the step of biometrically identifying: emitting, toward the body part, an optical signal carrying the code, and detecting remission of the optical signal by the body part to generate a recording of the code; and communicating, to the authenticator, (a) an indication of identity of the user, as obtained in the step of biometrically identifying, and (b) the recording.

(B) In the passwordless authentication method denoted as (A), the recording does not include a biometric image of the body part.

(C) Either of the passwordless authentication methods denoted as (A) or (B), further including: receiving a two-dimensional barcode encoding address of the authenticator; and in the step of communicating, sending the indication and the recording to the address.

(D) In any of the passwordless authentication methods denoted as (A)-(C), the step of receiving comprising receiving the two-dimensional barcode from a camera.

(E) Any of the passwordless authentication methods denoted as (A)-(D), further including commanding the camera to capture an image of a display of the two-dimensional barcode.

(F) In any of the passwordless authentication methods denoted as (A)-(E), the two-dimensional barcode further encoding a unique identifier that is unique within a time interval around time of the step of receiving the two-dimensional barcode, the step of communicating further comprising sending the unique identifier to the authenticator.

(G) In any of the passwordless authentication methods denoted as (A)-(F), the time interval being at least one minute.

(H) Any of the passwordless authentication methods denoted as (A)-(G), further including decrypting the two-dimensional barcode to extract therefrom the address and the unique identifier.

(I) In any of the passwordless authentication methods denoted as (A)-(H), the step of decrypting including decrypting the two-dimensional barcode using a private key that is updated by the authenticator on a regular basis.

(J) In any of the passwordless authentication methods denoted as (A)-(I), the step of encrypting including encrypting the two-dimensional barcode using a private key that is updated by the authenticator on a regular basis.

(K) Any of the passwordless authentication methods denoted as (A)-(J), further including encrypting the indication and the recording prior to the step of communicating.

(L) Any of the passwordless authentication methods denoted as (A)-(K), including performing the steps of emitting and detecting within a predefined time of the step of biometrically identifying.

(M) In any of the passwordless authentication methods denoted as (A)-(L), the predefined time being less than five seconds.

(N) Any of the passwordless authentication methods denoted as (A)-(M), further including: obtaining evidence of aliveness of the user through interrogation of the body part; and in the step of communicating, communicating the evidence to the authenticator.

(O) Any of the passwordless authentication methods denoted as (A)-(N), further including: comparing biometric data obtained in the step of biometrically identifying with biometric data obtained from the remission, to validate that the remission is from the body part interrogated in the step of biometrically identifying; and in the step of communicating, communicating a validation outcome, obtained in the step of comparing, to the authenticator.

(P) A passwordless authentication method, including: receiving a code; emitting, to a body part of a user, a temporally modulated signal that is temporally modulated according to the code; detecting the temporally modulated signal as remitted by the body part of the user; and communicating a recording of the temporally modulated signal, as remitted, to an authenticator.

(Q) In the passwordless authentication method denoted as (P), the recording does not include a biometric image of the body part.

(R) In either of the passwordless authentication methods denoted as (P) or (Q), the step of receiving including capturing a movie of a temporally modulated element of a webpage.

(S) In any of the passwordless authentication methods denoted as (P)-(R), the step of receiving including extracting specification of the temporally modulated signal from a two-dimensional barcode.

(T) Any of the passwordless authentication methods denoted as (P)-(S), further including capturing an image of the two-dimensional barcode displayed on a webpage.

(U) Any of the passwordless authentication methods denoted as (P)-(T), including: in the step of emitting, optically emitting the temporally modulated signal; and in the step of detecting, optically detecting the temporally modulated signal as remitted.

(V) In any of the passwordless authentication methods denoted as (P)-(U), the body part being face of the user.

(W) In any of the passwordless authentication methods denoted as (P)-(V), the step of optically detecting including using a non-imaging photodetector to detect the temporally modulated signal as remitted.

(X) In any of the passwordless authentication methods denoted as (P)-(W), the step of optically detecting including using a camera to capture an image series of the face to detect the temporally modulated signal as remitted.

(Y) Any of the passwordless authentication methods denoted as (P)-(X), further including processing the image series to generate the recording such that the recording does not include an image of the face.

(Z) Any of the passwordless authentication methods denoted as (P)-(Y), further including capturing at least one image of the face to enable identification of the user from face recognition.

(AA) Any of the passwordless authentication methods denoted as (P)-(Z), including using the camera to capture the at least one image.

(AB) Any of the passwordless authentication methods denoted as (P)-(AA), including performing the step of capturing within a predefined time of the step of optically detecting.

(AC) Any of the passwordless authentication methods denoted as (P)-(AB), the predefined time being less than five seconds.

(AD) Any of the passwordless authentication methods denoted as (P)-(AC), including using a face-recognition camera to capture the at least one image.

(AE) Any of the passwordless authentication methods denoted as (P)-(AD), including performing the steps of capturing and optically detecting simultaneously.

(AF) Any of the passwordless authentication methods denoted as (P)-(AE), the step of optically detecting including: capturing a plurality of images of the face; and extracting the temporally modulated signal, as remitted, from the plurality of images.

(AG) Any of the passwordless authentication methods denoted as (P)-(AF), further including performing face recognition based upon one or more of the plurality of images to determine identity of the user.

(AH) Any of the passwordless authentication methods denoted as (P)-(AG), further including communicating an indication of the identity to the authenticator.

(AI) Any of the passwordless authentication methods denoted as (P)-(AH), the body part being a finger of the user.

(AJ) Any of the passwordless authentication methods denoted as (P)-(AI), including performing the step of optically detecting using a photodetector positioned below a light-transmissive fingerprint sensor.

(AK) Any of the passwordless authentication methods denoted as (P)-(AJ), the light-transmissive fingerprint sensor being an ultrasound fingerprint sensor.

(AL) Any of the passwordless authentication methods denoted as (P)-(AK), the light-transmissive fingerprint sensor being an optical fingerprint sensor.

(AM) Any of the passwordless authentication methods denoted as (P)-(AL), further including imaging the finger, using the light-transmissive ultrasound-based fingerprint sensor, to obtain a fingerprint of the finger.

(AN) Any of the passwordless authentication methods denoted as (P)-(AM), further including determining identity of the user based upon the fingerprint.

(AO) Any of the passwordless authentication methods denoted as (P)-(AN), further including communicating an indication of the identity to the authenticator.

(AP) Any of the passwordless authentication methods denoted as (P)-(AO), including performing the steps of emitting, optically detecting, and imaging simultaneously.

(AQ) In any of the passwordless authentication methods denoted as (P)-(AP), performing the steps of emitting and optically detecting within a predefined time of the step of imaging.

(AR) Any of the passwordless authentication methods denoted as (P)-(AQ), the predefined time being less than five seconds.

(AS) Any of the passwordless authentication methods denoted as (P)-(AR), the step of capturing including capturing a movie of a temporally modulated element of a webpage.

(AT) Any of the passwordless authentication methods denoted as (P)-(AS), including: in the step of emitting, emitting a temporally modulated ultrasound signal to a finger of the user; and in the step of detecting, detecting the temporally modulated ultrasound signal as remitted by the finger, using an ultrasound fingerprint sensor.

(AU) Any of the passwordless authentication methods denoted as (P)-(AT), further including ultrasound imaging the finger, with the ultrasound fingerprint sensor, to obtain a fingerprint of the user.

(AV) A finger interrogation method for passwordless authentication, including: imaging a finger to obtain a fingerprint image; and concurrently with the step of imaging: illuminating the finger with a temporally modulated optical signal, and recording the temporally modulated optical signal as remitted by the finger.

(AW) In the finger interrogation method denoted as (AV), the step of recording including generating a recording of the temporally modulated optical signal, as remitted, that does not include a biometric image of the finger.

(AX) In either of the finger interrogation methods denoted as (AV) or (AW), including: in the step of imaging, ultrasonically imaging the finger along an ultrasound interrogation path between an ultrasound transducer and the finger; and performing at least one of the steps of illuminating and recording at least partly along the ultrasound interrogation path.

(AY) Any of the finger interrogation methods denoted as (AV)-(AX), including: in the step of imaging, optically imaging the finger along an optical interrogation path between an image sensor and the finger; and performing at least one of the steps of illuminating and recording at least partly along the optical interrogation path.

(AZ) Any of the finger interrogation methods denoted as (AV)-(AY), including: in the step of imaging, imaging the finger using a light-transmissive sensor; and in the step of recording, detecting the temporally modulated optical signal, as remitted by the finger, through the light-transmissive sensor.

(BA) In any of the finger interrogation methods denoted as (AV)-(AZ), the step of illuminating further including emitting the temporally modulated optical signal from a light source to the finger through the light-transmissive sensor.

(BB) In any of the finger interrogation methods denoted as (AV)-(BA), the light source being a display.

(BC) In any of the finger interrogation methods denoted as (AV)-(BB), the step of illuminating further including emitting the temporally modulated optical signal from a light source to the finger via an emission path that is not along the interrogation path.

(BD) In any of the finger interrogation methods denoted as (AV)-(BC), the step of illuminating comprising emitting a sequence of light flashes toward the finger.

(BE) In any of the finger interrogation methods denoted as (AV)-(BD), the light flashes originating from a plurality of different locations to form a spatiotemporally modulated pattern.

(BF) Any of the finger interrogation methods denoted as (AV)-(BE), including performing the steps of illuminating and recording within a predefined time from the step of ultrasonically imaging.

(BG) In any of the finger interrogation methods denoted as (AV)-(BF), the predefined time being less than five seconds.

(BH) Any of the finger interrogation methods denoted as (AV)-(BG), further including concurrently with the step of imaging, sensing a property of the finger indicative of aliveness of the finger.

(BI) In any of the finger interrogation methods denoted as (AV)-(BH), the step of sensing including sensing a heartbeat of the finger.

(BJ) In any of the finger interrogation methods denoted as (AV)-(BI), the step of sensing including sensing an oxygenation level of the finger.

(BK) Any of the finger interrogation methods denoted as (AV)-(BJ), including performing the step of sensing within a predefined time from the step of imaging.

(BL) In any of the finger interrogation methods denoted as (AV)-(BK), the predefined time being less than five seconds.

(BM) In any of the finger interrogation methods denoted as (AV)-(BL), the temporally modulated signal being in a first wavelength range, the step of sensing comprising optically measuring the property in a second wavelength range that does not overlap with the first wavelength range.

(BN) A finger interrogation method for passwordless authentication, including:

imaging a finger to obtain a fingerprint image; and concurrently with the step of imaging: illuminating the finger with a temporally modulated ultrasound signal, and recording the temporally modulated ultrasound signal as remitted by the finger.

(BO) A face interrogation method for passwordless authentication, including: optically interrogating a face of a user to determine identity of the user based upon the face; and concurrently with the step of optically interrogating: illuminating the face with a temporally modulated optical signal, and recording the temporally modulated optical signal as remitted by the face.

(BP) In the finger interrogation method denoted as (BO), the step of recording including generating a recording of the temporally modulated optical signal, as remitted, that does not include a biometric image of the face.

(BQ) In either of the face interrogation methods denoted as (BO) or (BP), the step of illuminating including emitting a sequence of light flashes toward the face.

(BR) In any of the face interrogation methods denoted as (BO)-(BQ), the step of recording including detecting the temporally modulated optical signal, as remitted, using a non-imaging photodetector.

(BS) In any of the face interrogation methods denoted as (BO)-(BR), the light flashes being infrared.

(BT) Any of the face interrogation methods denoted as (BO)-(BS), including performing the steps of illuminating and recording within a predefined time from the step of optically interrogating.

(BU) In any of the face interrogation methods denoted as (BO)-(BT), the predefined time being less than five seconds.

(BV) Any of the face interrogation methods denoted as (BO)-(BU), further including, concurrently with the step of optically interrogating, imaging the face to evaluate a response of the user to a challenge, so as to assess aliveness of the face.

(BW) In any of the face interrogation methods denoted as (BO)-(BV), the step of imaging including tracking facial movement of the user in response to the challenge.

(BX) In any of the face interrogation methods denoted as (BO)-(BW), including performing the step of imaging within a predefined time from the step of optically interrogating.

(BY) In any of the face interrogation methods denoted as (BO)-(BX), the predefined time being less than five seconds.

(BZ) Any of the face interrogation methods denoted as (BO)-(BY), further including: in the step of optically interrogating, capturing at least one image of the face, using a camera; and in the step of recording, detecting, using the camera, remission of the temporally modulated optical signal by the face.

(CA) In any of the face interrogation methods denoted as (BO)-(ZQ), the temporally modulated optical signal forming a spatial pattern on the face, step of capturing including capturing the at least one image of the face when illuminated by the spatial pattern, to enable determination of the identity based at least in part upon the at least one image.

(CB) A mobile-device aided method for passwordless authentication of user to exchange restricted-access data with a server via a remote computer, including: receiving an address for a communication channel to the remote computer; communicating webpage content to the address, the webpage content including a temporally modulated pattern; receiving from a mobile device separate from the remote computer (a) an indication of identity of the user of the mobile device, as biometrically determined by the mobile device, and (b) a recording of the temporally modulated pattern, as remitted by a body part of the user; and authenticating the user to exchange, via the address, the restricted-access data with the server only if (a) the identity, as indicated by the indication, matches a user record and (b) the recording matches the temporally modulated pattern included in the webpage content.

(CC) In the mobile-device aided method denoted as (CB), the step of authenticating further including requiring, to authenticate the user, receipt of evidence from the mobile device that the body part is alive.

(CD) Either of the mobile-device aided methods denoted as (CB)-(CC), further including: in the step of communicating, communicating, as part of the webpage content, a two-dimensional barcode encoding a unique identifier that is unique within a time interval around time of communicating the two-dimensional barcode to the address; and after the step of communicating the two-dimensional barcode to the address, receiving, from the mobile device, the unique identifier.

(CE) In any of the mobile-device aided methods denoted as (CB)-(CD), the two-dimensional barcode further encoding a server address to be used by the mobile device to send data to the server.

(CF) In any of the mobile-device aided methods denoted as (CB)-(CE), the time interval being at least one minute.

(CG) In any of the mobile-device aided methods denoted as (CB)-(CF), the step of communicating including: communicating the two-dimensional bar code to the address prior to communicating the temporally modulated pattern to the address; and communicating the temporally modulated pattern to the address only after receiving the information from the mobile device.

(CH) Any of the mobile-device aided methods denoted as (CB)-(CG), further including: communicating webpage content to the address to display a challenge on a webpage open on a screen of the remote computer; receiving, from the mobile device a camera-based recording of a physical response of the user to the challenge; and in the step of authenticating, further requiring that (c) the physical response, as recorded by the mobile device, is consistent with the challenge.

(CI) In any of the mobile-device aided methods denoted as (CB)-(CH), further including: communicating a challenge to the mobile device; receiving, from the remote computer, a recording of a physical response of the user to the challenge; and in the step of authenticating, further requiring that (c) the physical response, as recorded by the remote computer, is consistent with the challenge.

(CJ) A facial-movement tracking method for passwordless authentication, including: imaging face of a user to determine identity of the user based upon the face; and concurrently with the step of imaging, tracking facial movement of the user in response to a challenge.

(CK) The facial-movement tracking method denoted as (CJ), further including: communicating, to an authenticator, (a) an indication of the identity obtained in the step of imaging and (b) a recording of facial movement obtained in the step of tracking. The facial-movement tracking method of claim 88, further including: displaying a plurality of visual elements in a respective plurality of different local regions of a screen; and in the step of tracking, tracking gaze direction, of the user, at the different local regions of the screen.

(CL) Any of the facial-movement tracking methods denoted as (CJ)-(CK), further including communicating, to an authenticator, (a) an indication of the identity obtained in the step of imaging and (b) a sequence of gaze directions obtained in the step of tracking.

(CM) Any of the facial-movement tracking methods denoted as (CJ)-(CL), including performing the step of tracking within a predefined time from the step of imaging.

(CN) In any of the facial-movement tracking methods denoted as (CJ)-(CM), the predefined time being less than five seconds.

(CO) A mobile-device aided method for passwordless authentication of user to exchange restricted-access data with a server via a remote computer, including: receiving an address for a communication channel to the remote computer; communicating webpage content to the address to display a first challenge on a webpage open on a screen of the remote computer; receiving, from a mobile device separate from the remote computer, (a) an indication of identity of the user of the mobile device, as biometrically determined by the mobile device, and (b) a camera-based recording of a first physical response of the user to the first challenge; and authenticating the user to exchange, via the address, the restricted-access data with the server only if (a) the identity, indicated by the indication, matches a user record and (b) the first physical response, as captured in the camera-based recording, is consistent with the first challenge.

(CP) In the mobile-device aided method denoted as (CO), the step of authenticating further including requiring, to authenticate the user, that the physical response, as captured in the camera-based recording is consistent with a user record containing behavioral biometric characteristics of the user.

(CQ) Either of the mobile-device aided methods denoted as (CO) or (CP), further including: prior to the step of authenticating, communicating a second challenge to the mobile device; receiving, from the remote computer, a recording of a second physical response by the user to the second challenge; and in the step of authenticating, further requiring that (c) the second physical response, as recorded by the remote computer, is consistent with the second challenge.

(CR) A mobile-device aided method for passwordless authentication of user to exchange restricted-access data with a server via a remote computer, including: receiving address for a communication channel to the remote computer; commanding webpage content to the address to display of a challenge on a webpage open on a screen of the remote computer; receiving from a mobile device, separate from the remote computer, a camera-based recording of a physical response of the user to the challenge; and authenticating the user to exchange, via the address, the restricted-access data with the server only if the physical response, as captured in the camera-based recording, is consistent with (a) the challenge and (b) a user record containing behavioral biometric characteristics of the user.

(CS) A passwordless authentication method, including: receiving, within a mobile device, a flash pattern included on a webpage by an authenticator; biometrically authenticating, at the mobile device, a body part of a user of the mobile device; concurrently with the step of biometrically authenticating: emitting, toward the body part, a modulated optical signal based upon the flash pattern, and recording detected remission of the modulated optical signal by the body part as a remitted pattern; and communicating, to the authenticator, (a) an indication of authenticity of the user, as determined by the step of biometrically authenticating, and (b) the remitted pattern. The user is authenticated to the webpage based upon the indication of authenticity and a match of the remitted pattern to the flash pattern.

(CT) The passwordless authentication method denoted as (CS), further including: receiving a two-dimensional barcode encoding a URL of the authenticator; and in the step of communicating, sending the indication and the remitted pattern using the URL.

(CU) In either of the passwordless authentication methods denoted as (CS) or (CT), the steps of receiving including: capturing, using a camera of the mobile device, a plurality of images of the webpage displayed on a computer screen of a user computer; determining the flash pattern based upon temporal changes within the plurality of mages; and determining the two-dimensional barcode from at least one of the plurality of images.

(CV) In any of the passwordless authentication methods denoted as (CS)-(CU), the steps of receiving including: capturing, using a camera of the mobile device, at least one image of the webpage displayed on a computer screen of a user computer; and determining the two-dimensional barcode from the at least one image. The flash pattern is encoded in the two-dimensional barcode.

(CW) In any of the passwordless authentication methods denoted as (CS)-(CV), further including decoding a unique identifier from the two-dimensional barcode, wherein the unique identifier is unique within a time interval around a time of capturing the plurality of images, the step of communicating further comprising communicating the unique identifier to the authenticator.

(CX) In any of the passwordless authentication methods denoted as (CS)-(CW), the time interval being at least one minute.

(CY) In any of the passwordless authentication methods denoted as (CS)-(CX), the remitted pattern being free of biometric data of the body part and comprising temporal data comparable to the flash pattern.

(CZ) Any of the passwordless authentication methods denoted as (CS)-(CY), further including encoding the remitted pattern to make it different from the flash pattern, the remitted pattern indicating a scam attempt when not encoded.

(DA) In any of the passwordless authentication methods denoted as (CS)-(CZ), the body part being one of (a) a face of the user and (b) a finger of the user, the step of biometric authenticating comprising one of (c) facial recognition and (d) fingerprint recognition.

(DB) In any of the passwordless authentication methods denoted as (CS)-(DA), the steps of emitting and recording being performed within five seconds of the step of biometrically identifying.

(DC) Any of the passwordless authentication methods denoted as (CS)-(DB), further including: comparing biometric data obtained in the step of biometrically identifying with biometric data obtained from the remission, to validate that the remission is from the body part interrogated in the step of biometrically identifying; and in the step of communicating, communicating a validation outcome, obtained in the step of comparing, to the authenticator.

(DD) In any of the passwordless authentication methods denoted as (CS)-(DC), the step of emitting the modulated optical signal comprising controlling a display of the mobile device to emit the modulated optical signal based upon the flash pattern.

(DE) Any of the passwordless authentication methods denoted as (CS)-(DD), further including: receiving, directly from the authenticator, and not via the webpage, a character based code; and displaying the character based code on the display of the mobile device. The authenticator matches the input character based code, received via the website when entered by the user, to the generated character based code, to authenticate the user to the webpage.

(DF) A passwordless authentication method, including: receiving, at an authentication server, a computer address of a communication channel to a user computer of a user; communicating webpage content to the computer address, the webpage content including a temporally modulated pattern; receiving from a mobile device separate from the user computer (a) an indication of authentication of the user to the mobile device, as biometrically determined by the mobile device, and (b) a recording of remission of the temporally modulated pattern by a body part of the user; and authenticating the user to exchange, via the computer address, restricted-access data with a data server only if (a) the identity, as indicated by the indication, matches a user record of the data server and (b) the recording matches the temporally modulated pattern included in the webpage content.

(DG) In the passwordless authentication method denoted as (DF), the step of authenticating further including validating, to authenticate the user, receipt of evidence from the mobile device that the body part is alive.

(DH) Either of the passwordless authentication methods denoted as (DF) or (DG), further including: in the step of communicating, communicating, as part of the webpage content, a two-dimensional barcode encoding a unique identifier that is unique within a time interval around time of communicating the two-dimensional barcode to the address; and after the step of communicating the two-dimensional barcode to the address, receiving, from the mobile device, the unique identifier.

(DI) In any of the passwordless authentication methods denoted as (DF)-(DH), the two-dimensional barcode further encoding a URL of the authentication server for use by the mobile device to send data to the authentication server.

(DJ) In any of the passwordless authentication methods denoted as (DF)-(DI), the step of communicating including: communicating the two-dimensional bar code to the computer address prior to communicating the temporally modulated pattern to the computer address; and communicating the temporally modulated pattern to the address only after receiving the unique identifier from the mobile device.

(DK) Any of the passwordless authentication methods denoted as (DF)-(DJ), further including: communicating webpage content to the computer address to display a challenge command on a computer screen of the user computer; receiving, from the mobile device a recorded physical response of the user to the challenge command; and in the step of authenticating, further requiring that (c) the physical response, as recorded by the mobile device, is consistent with the challenge.

(DL) Any of the passwordless authentication methods denoted as (DF)-(DK), further including: communicating a challenge command to the mobile device; receiving, from the mobile device, a recording of a physical response of the user to the challenge; and in the step of authenticating, further requiring that (c) the physical response, as recorded by the mobile device, is consistent with the challenge.

(DM) In any of the passwordless authentication methods denoted as (DF)-(DL), further including: generating a character based code; sending the character based code to directly, and not via the webpage, to the mobile device; receiving, via the webpage an input character based code; and authenticating the user to the webpage when the input character based code matches the generated character based code.

(DN) A facial-movement tracking method, including: imaging, at a mobile device, face of a user to authenticate the user to the mobile device based upon the face; and concurrently with the step of imaging, tracking facial movement of the user in response to a challenge command.

(DO) The facial-movement tracking method denoted as (DN), further including communicating, to an authenticator, (a) an indication of an identity obtained in the step of imaging and (b) a recording of facial movement obtained in the step of tracking.

(DP) Either of the facial-movement tracking methods denoted as (DN) or (DO), further including: displaying a plurality of visual elements in a respective plurality of different local regions of a screen of the mobile device; and in the step of tracking, tracking gaze direction, of the user, at the different local regions of the screen, the recording of facial movement comprising eye movements.

(DQ) In any of the facial-movement tracking methods denoted as (DN)-(DP), the facial movement including one or more of blinking, smiling, speaking, mouthing, head tilting, head shaking, nodding, and yawning.

(DR) A passwordless authentication method, including: receiving, within a mobile device, a 2D barcode included on a webpage by an authenticator; decoding a unique ID from the 2D barcode; decoding a URL of the authenticator from the 2D barcode; sending the unique ID to the authenticator using the URL; receiving a challenge command from the authenticator via the website; outputting the challenge command to a user of the mobile device; biometrically authenticating the user at the mobile device; and concurrently with the step of biometrically authenticating, detecting a response of the user following the challenge command; communicating, to the authenticator, (a) an indication of authenticity of the user, as determined by the step of biometrically authenticating, and (b) the response of the user. The user is authenticated to the webpage based upon the indication of authenticity and a match of the response to the challenge command.

(DS) In the passwordless authentication method denoted as (DR), the step of detecting the response, including detecting movement of the user based upon a plurality of images captured by a camera of the mobile device during the biometric authentication.

(DT) In either of the passwordless authentication methods denoted as (DR) or (DS), the step of detecting the response, including detecting a photoplethysmogram (PPG) of the user during the biometric authentication, the PPG including changes resulting from actions of the user following the challenge command during the biometric authentication.

Without departing from the scope hereof, any one of processes 300, 400, 500, 600, 800, and 900 may be adapted to be performed without user computer 140/740, such that mobile device 120/720 additionally performs the functions of user computer 140/740. For example, application 130/730 running on mobile device 120/720 may operate the display (e.g., display 727) in a split configuration (e.g., a split view), with a first portion of the display providing the content (e.g., webpage 152/752) that otherwise would have been provided by user computer 140/740. Actions performed by camera 122/722 of mobile device 120/720 to obtain information from computer screen 142/742 (e.g., a flashing pattern), may be implemented as actions of mobile device 120/720 obtaining this information from 2D barcode 168/768 received directly from authentication server 160/760. In one example of such implementation, 2D barcode 168/768 is displayed in one portion of the split view, and the application provides a cursor with a square that the user may place over the 2D barcode to read the 2D barcode.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A passwordless authentication method, comprising:
receiving, within a mobile device, a flash pattern included on a webpage by an authenticator;
biometrically authenticating, at the mobile device, a body part of a user of the mobile device;
concurrently with the step of biometrically authenticating:
emitting, toward the body part, a modulated optical signal based upon the flash pattern, and
recording detected remission of the modulated optical signal by the body part as a remitted pattern; and
communicating, to the authenticator, (a) an indication of authenticity of the user, as determined by the step of biometrically authenticating, and (b) the remitted pattern;
the user being authenticated to the webpage based upon the indication of authenticity and a match of the remitted pattern to the flash pattern.

2. The passwordless authentication method of claim 1, further comprising:
receiving a two-dimensional barcode encoding a URL of the authenticator; and
in the step of communicating, sending the indication and the remitted pattern using the URL.

3. The passwordless authentication method of claim 2, the steps of receiving comprising:
capturing, using a camera of the mobile device, a plurality of images of the webpage displayed on a computer screen of a user computer;
determining the flash pattern based upon temporal changes within the plurality of mages; and
determining the two-dimensional barcode from at least one of the plurality of images.

4. The passwordless authentication method of claim 3, the steps of receiving comprising:
capturing, using a camera of the mobile device, at least one image of the webpage displayed on a computer screen of a user computer; and
determining the two-dimensional barcode from the at least one image;
the flash pattern being encoded in the two-dimensional barcode.

5. The passwordless authentication method of claim 4, further comprising decoding a unique identifier from the two-dimensional barcode, wherein the unique identifier is unique within a time interval around a time of capturing the plurality of images, the step of communicating further comprising communicating the unique identifier to the authenticator.

6. The passwordless authentication method of claim 5, the time interval being at least one minute.

7. The passwordless authentication method of claim 6, the remitted pattern being free of biometric data of the body part and comprising temporal changes comparable to the flash pattern.

8. The passwordless authentication method of claim 7, further comprising encoding the remitted pattern to make it different from the flash pattern, the remitted pattern indicating a scam attempt when not encoded.

9. The passwordless authentication method of claim 8, the body part being one of (a) a face of the user and (b) a finger of the user, the step of biometric authenticating comprising one of (c) facial recognition and (d) fingerprint recognition.

10. The passwordless authentication method of claim 9, the steps of emitting and recording being performed within five seconds of the step of biometrically identifying.

11. The passwordless authentication method of claim 10, further comprising:
comparing biometric data obtained in the step of biometrically identifying with biometric data obtained from the remission, to validate that the remission is from the body part interrogated in the step of biometrically identifying; and
in the step of communicating, communicating a validation outcome, obtained in the step of comparing, to the authenticator.

12. The passwordless authentication method of claim 11, the step of emitting the modulated optical signal comprising controlling a display of the mobile device to emit the modulated optical signal based upon the flash pattern.

13. The passwordless authentication method of claim 12, further comprising:
receiving, directly from the authenticator, and not via the webpage, a character based code; and
displaying the character based code on the display of the mobile device;
wherein the authenticator matches the input character based code, received via the website when entered by the user, to the generated character based code, to authenticate the user to the webpage.

14. A passwordless authentication method, comprising:
receiving, at an authentication server, a computer address of a communication channel to a user computer of a user;
communicating webpage content to the computer address, the webpage content including a temporally modulated pattern;
receiving from a mobile device separate from the user computer (a) an indication of authentication of the user to the mobile device, as biometrically determined by the mobile device, and (b) a recording of remission of the temporally modulated pattern by a body part of the user; and
authenticating the user to exchange, via the computer address, restricted-access data with a data server only if (a) the identity, as indicated by the indication, matches a user record of the data server and (b) the recording matches the temporally modulated pattern included in the webpage content.

15. The passwordless authentication method of claim 14, the step of authenticating further comprising validating, to authenticate the user, receipt of evidence from the mobile device that the body part is alive.

16. The passwordless authentication method of claim 15, further comprising:
in the step of communicating, communicating, as part of the webpage content, a two-dimensional barcode encoding a unique identifier that is unique within a time interval around time of communicating the two-dimensional barcode to the address; and
after the step of communicating the two-dimensional barcode to the address, receiving, from the mobile device, the unique identifier.

17. The passwordless authentication method of claim 16, the two-dimensional barcode further encoding a URL of the authentication server for use by the mobile device to send data to the authentication server.

18. The passwordless authentication method of claim 17, the step of communicating comprising:
communicating the two-dimensional bar code to the computer address prior to communicating the temporally modulated pattern to the computer address; and
communicating the temporally modulated pattern to the address only after receiving the unique identifier from the mobile device.

19. The passwordless authentication method of claim 18, further comprising:
communicating webpage content to the computer address to display a challenge command on a computer screen of the user computer;
receiving, from the mobile device a recorded physical response of the user to the challenge command; and
in the step of authenticating, further requiring that (c) the physical response, as recorded by the mobile device, is consistent with the challenge.

20. The passwordless authentication method of claim 19, further comprising:
communicating a challenge command to the mobile device;
receiving, from the mobile device, a recording of a physical response of the user to the challenge; and
in the step of authenticating, further requiring that (c) the physical response, as recorded by the mobile device, is consistent with the challenge.

21. The passwordless authentication method of claim 20, further comprising:
generating a character based code;
sending the character based code to directly, and not via the webpage, to the mobile device;
receiving, via the webpage an input character based code; and
authenticating the user to the webpage when the input character based code matches the generated character based code.

22. A facial-movement tracking method, comprising:
imaging, at a mobile device, face of a user to authenticate the user to the mobile device based upon the face; and
concurrently with the step of imaging, tracking facial movement of the user in response to a challenge command.

23. The facial-movement tracking method of claim 22, further comprising:
communicating, to an authenticator, (a) an indication of an identity obtained in the step of imaging and (b) a recording of facial movement obtained in the step of tracking.

24. The facial-movement tracking method of claim 23, further comprising:
displaying a plurality of visual elements in a respective plurality of different local regions of a screen of the mobile device; and
in the step of tracking, tracking gaze direction, of the user, at the different local regions of the screen, the recording of facial movement comprising eye movements.

25. The facial-movement tracking method of claim 24, the facial movement comprising one or more of blinking, smiling, speaking, mouthing, head tilting, head shaking, nodding, and yawning.

26. A passwordless authentication method, comprising:
receiving, within a mobile device, a 2D barcode included on a webpage by an authenticator;
decoding a unique ID from the 2D barcode;
decoding a URL of the authenticator from the 2D barcode;
sending the unique ID to the authenticator using the URL;
receiving a challenge command from the authenticator via the website;
outputting the challenge command to a user of the mobile device;
biometrically authenticating the user at the mobile device;
concurrently with the step of biometrically authenticating, detecting a response of the user following the challenge command;
communicating, to the authenticator, (a) an indication of authenticity of the user, as determined by the step of biometrically authenticating, and (b) the response of the user;
the user being authenticated to the webpage based upon the indication of authenticity and a match of the response to the challenge command.

27. The passwordless authentication method of claim 26, the step of detecting the response, comprising detecting movement of the user based upon a plurality of images captured by a camera of the mobile device during the biometric authentication.

28. The passwordless authentication method of claim 26, the step of detecting the response, comprising detecting a photoplethysmogram (PPG) of the user during the biometric authentication, the PPG including changes resulting from actions of the user following the challenge command during the biometric authentication.
